(19) United States
(12) Patent Application Publication
(10) Pub. No.: US 2021/0272732 A1
(43) Pub. Date: Sep. 2, 2021

(54) MAGNETIC BODY HOLDING DEVICE AND MAGNETIC BODY HOLDING SYSTEM INCLUDING SAME

(71) Applicant: Tae Kwang CHOI, Gwangmyeong-si (KR)

(72) Inventor: Tae Kwang CHOI, Gwangmyeong-si (KR)

(21) Appl. No.: 17/137,073

(22) Filed: Dec. 29, 2020

(30) Foreign Application Priority Data
Feb. 28, 2020 (KR) 10-2020-0024938
Jun. 5, 2020 (KR) 10-2020-0068594

(51) Int. Cl. H01F 7/02; H01F 7/20

(52) U.S. Cl. CPC H01F 7/0252; H01F 2007/208; H01F 7/206

(57) ABSTRACT

A magnetic body holding device includes: a first pole piece having a first interaction surface and a second interaction surface; a second pole piece having a third interaction surface and a fourth interaction surface; a first stationary magnet disposed to be adjacent to the first interaction surface and the third interaction surface; a second stationary magnet disposed to be adjacent to the second interaction surface and the fourth interaction surface; a rotary magnet rotatably disposed between the first stationary magnet and the second stationary magnet; a first coil disposed between the first stationary magnet and the rotary magnet and wound around at least one of the first pole piece and the second pole piece; and a second coil disposed between the second stationary magnet and the rotary magnet and wound around at least one of the first pole piece and the second pole piece.

### CROSS-REFERENCE TO RELATED APPLICATIONS

This application claims the priority of Korean Patent Application No 10-2020-0024938 filed on Feb. 28, 2020, and No 10-2020-0068594 filed on Jun. 5, 2020, in the Korean Intellectual Property Office, the disclosure of which is incorporated herein by reference.

### BACKGROUND

### Field

The present disclosure relates to a magnetic body holding device configured to hold a magnetic body by controlling magnetic force, and to a magnetic body holding system including the magnetic body holding device.

### Description of the Related Art

A magnetic body holding device, such as a permanent magnet workpiece holding device, refers to a device used to attach, by using a magnetic force, an attachment object made of a magnetic material such as iron. Recently, the magnetic body holding device is widely used as a mold clamp for an injection machine, a mold clamp for a press device, a chuck for a machine tool, or the like.

The magnetic body holding device attaches the attachment object, which is a magnetic body, to an interaction surface by using high magnetic force of a permanent magnet in order to hold the attachment object, and the magnetic body holding device separates the attachment object from the interaction surface by preventing a magnetic flow of the permanent magnet from being formed on the interaction surface in order to release the attachment object.

In the related art, there is disclosed a magnetic body holding device that holds or release an object by changing a magnetic flow in the device by rotating a permanent magnet (see Patent Document 1).

In the magnetic body holding device disclosed in Patent Document 1, a permanent magnet and a rotary permanent magnet are disposed between pole pieces disposed at both sides, and the permanent magnet and the rotary permanent magnet are arranged in an up-down direction (or a vertical direction). In the case of the magnetic body holding device disclosed in Patent Document 1, because a height of the magnetic body holding device in the up-down direction is large, the magnetic body holding device cannot be applied to a structure in which an installation space for the magnetic body holding device is narrow, particularly, a structure in which a height of the installation space is small. As a result, there is a problem in that the structure to which the magnetic body holding device may be applied is greatly restricted spatially.

In addition, in the case of the structure of the magnetic body holding device disclosed in Patent Document 1, if an overall size of the magnetic body holding device is reduced to reduce a height of the magnetic body holding device, there is a problem in that holding force for holding a holding object is decreased.

In addition, if an overall size of the magnetic body holding device is reduced, an interval between the pole pieces is also reduced. In this case, there is concern that the holding object is released as the rotary permanent magnet is inadvertently rotated by external force in the state in which the holding object is held.

### (Patent Document 1)

Korean Patent Application Laid-Open No. 10-2019-0031133 (entitled MAGNETIC FORCE CONTROL DEVICE AND MAGNETIC SUBSTANCE HOLDING DEVICE USING THE SAME)

### SUMMARY

An object to be achieved by the present disclosure is to provide a magnetic body holding device improved to be installed even in a narrow space having a small height, and a magnetic body holding system having the magnetic body holding device.

Another object to be achieved by the present disclosure is to provide a magnetic body holding device improved to stably hold or release a magnetic body even with low electric power, and a magnetic body holding system having the magnetic body holding device.

Technical problems of the present disclosure are not limited to the aforementioned technical problems, and other technical problems, which are not mentioned above, may be clearly understood by those skilled in the art from the following descriptions.

According to an aspect of the present disclosure, a magnetic body holding device may include: a first pole piece having a first interaction surface and a second interaction surface; a second pole piece spaced apart from the first pole piece and having a third interaction surface and a fourth interaction surface; a first stationary magnet supported between the first pole piece and the second pole piece and disposed to be adjacent to the first interaction surface and the third interaction surface; a second stationary magnet supported between the first pole piece and the second pole piece and disposed to be adjacent to the second interaction surface and the fourth interaction surface; a rotary magnet rotatably disposed between the first stationary magnet and the second stationary magnet; a first coil disposed between the first stationary magnet and the rotary magnet and wound around at least one of the first pole piece and the second pole piece; and a second coil disposed between the second stationary magnet and the rotary magnet and wound around at least one of the first pole piece and the second pole piece.

The rotary magnet may be disposed at a first position and a second position at which the rotary magnet rotated from the first position is positioned by controlling current flowing through the first coil and the second coil, the rotary magnet may form different magnetic closed loops together with the first stationary magnet and the second stationary magnet when the rotary magnet is disposed at the first position, and the rotary magnet may form a first magnetic flow, which diverges through the first interaction surface and the third interaction surface, and a second magnetic flow, which diverges through the second interaction surface and the fourth interaction surface, when the rotary magnet is disposed at the second position.

One portion of the rotary magnet may form a magnetic closed loop together with any one of the first stationary magnet and the second stationary magnet, and the other portion of the rotary magnet may form a magnetic flow that diverges through any one pair of interaction surfaces among the first interaction surface, the third interaction surface, the second interaction surface, and the fourth interaction surface.

The first stationary magnet may be disposed to be closer to the first interaction surface and the third interaction surface than the first coil.

The first stationary magnet may be disposed to be closer to the first interaction surface and the third interaction surface than the first rotary magnet.

According to another aspect of the present disclosure, a magnetic body holding device may include: a first magnetic body holding module including: a first pole piece assembly having a plurality of pole pieces made of a ferromagnetic material; a pair of first stationary magnets disposed between the plurality of pole pieces; and a first rotary magnet disposed between the pair of first stationary magnets and configured to form a magnetic closed loop together with at least one of the pair of first stationary magnets or form a magnetic flow that diverges to the outside of the first pole piece assembly; a second magnetic body holding module including: a second pole piece assembly having a plurality of pole pieces made of a ferromagnetic material; a pair of second stationary magnets disposed between the plurality of pole pieces; and a second rotary magnet disposed between the pair of second stationary magnets and configured to form a magnetic closed loop together with at least one of the pair of second stationary magnets or form a magnetic flow that diverges to the outside of the second pole piece assembly; a diamagnetic body disposed between the first magnetic body holding module and the second magnetic body holding module; and a plurality of coils shared by the first magnetic body holding module and the second magnetic body holding module.

At least one of the plurality of coils may be wound around at least one portion of the first pole piece assembly and at least one portion of the second pole piece assembly.

The plurality of coils may include: a first coil disposed between the first rotary magnet and any one of the pair of first stationary magnets and between the second rotary magnet and any one of the pair of second stationary magnets; and a second coil disposed between the first rotary magnet and the other of the pair of first stationary magnets and between the second rotary magnet and the other of the pair of second stationary magnets.

Any one of the pair of first stationary magnets and any one of the pair of second stationary magnets may be disposed so that the same poles face each other.

The first magnetic body holding module and the second magnetic body holding module may be disposed in a vertical direction.

The first pole piece assembly may include: a first pole piece having a first interaction surface and a second interaction surface; and a second pole piece having a third interaction surface and a fourth interaction surface, the second pole piece assembly may include: a third pole piece having a fifth interaction surface and a sixth interaction surface; and a fourth pole piece having a seventh interaction surface and an eighth interaction surface, and the diamagnetic body may be disposed between the second pole piece and the third pole piece.

The first interaction surface, the third interaction surface, the fifth interaction surface, and the seventh interaction surface may be disposed to be directed in a first direction, and the second interaction surface, the fourth interaction surface, the sixth interaction surface, and the eighth interaction surface may be disposed to be directed in a second direction opposite to the first direction.

The plurality of coils may be wound around the second pole piece and the third pole piece.

According to still another aspect of the present disclosure, a magnetic body holding device may include: at least one stationary magnet; at least one rotary magnet rotatably disposed; a plurality of pole pieces disposed to provide magnetic paths and having interaction surfaces on which a holding object is held; and a coil wound around at least one of the plurality of pole pieces, in which the plurality of pole pieces includes: a first pole piece configured to support the stationary magnet; and a second pole piece disposed adjacent to the first pole piece, and in which an interval between the first pole piece and the second pole piece is equal to or longer than 0.2 times of a diameter of the rotary magnet and equal to or shorter than 2 times the diameter of the rotary magnet.

The magnetic body holding device may further include: a sub-pole piece disposed to connect at least one portion of the first pole piece and at least one portion of the second pole piece and configured to form a magnetic closed loop together with at least one stationary magnet or at least one rotary magnet.

The sub-pole piece may be coupled to one end or the other end of the first pole piece and the second pole piece.

The sub-pole piece may be disposed at a lower side of at least one stationary magnet.

The rotary magnet may include: a shaft coupled to the rotary magnet by penetrating a center of the rotary magnet; a first cover coupled to one end of the first pole piece and one end of the second pole piece and configure the support one end of the shaft so that the shaft is rotatable; and a second cover coupled to the other end of the first pole piece and the other end of the second pole piece and configure the support the other end of the shaft so that the shaft is rotatable.

The first cover may include an insertion protrusion protruding from one surface of the first cover, which adjoins one end of the first pole piece and one end of the second pole piece, the insertion protrusion being inserted between the first pole piece and the second pole piece.

A cross-sectional area of at least one portion of the insertion protrusion may be decreased in a direction in which the insertion protrusion is inserted.

At least one portion of an outer surface of the insertion protrusion may be inclined in the direction in which the insertion protrusion is inserted.

The insertion protrusion may include a rounded portion formed at one end thereof.

The first cover may include a bearing coupled to the insertion protrusion and configured to support the shaft so that the shaft is rotatable. The bearing may include an outer race fixed to the insertion protrusion, and an inner race configured to be rotatable relative to the outer race, and the inner race may further protrude toward one end of the rotary magnet than the outer race.

The interaction surface may include a plurality of crests and at least one trough formed between the plurality of crests.

The interaction surface may include at least one engagement protrusion configured to engage with the holding object.

The rotary magnet may include a pair of magnet parts coupled to form a center hole.

A width of the interaction surface may be smaller than an average thickness of the first pole piece.

According to yet another aspect of the present disclosure, a magnetic body holding system may include: a magnetic body holding device including: at least one stationary magnet; at least one rotary magnet rotatably disposed; a plurality of pole pieces disposed to provide magnetic paths and having interaction surfaces on which a holding object is held; and a coil wound around at least one of the plurality of pole pieces; and a control device configured to hold the holding object on the interaction surface or release the holding object held on the interaction surface by controlling current flowing through the coil, in which the control device may include a detection sensor configured to detect a hold state or a release state of the holding object in conjunction with the magnetic body holding device.

The magnetic body holding device may include a cam configured to rotate in conjunction with a rotation of at least one rotary magnet. The detection sensor may include a sensor main body, and a switch connected to the sensor main body and configured to be pressed by the cam in accordance with the rotation of the cam.

The magnetic body holding device may include a shaft coupled to the rotary magnet by penetrating a center of the rotary magnet, and the cam may be coupled to one end of the shaft.

According to the present disclosure, there is no restriction to the size of the installation space in which the magnetic body holding device is installed, thereby improving spatial utilization.

In addition, the magnetic body holding device may stably hold the magnetic body by rotating the rotary magnet with the low electric power, thereby improving efficiency in operating the magnetic body holding device.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1A to 1D are views schematically illustrating a magnetic body holding device according to an exemplary embodiment of the present disclosure;

FIGS. 2A to 2D are views schematically illustrating a magnetic body holding device according to another exemplary embodiment of the present disclosure;

FIGS. 3A to 3D are views schematically illustrating a magnetic body holding device according to still another exemplary embodiment of the present disclosure;

FIGS. 4A to 4D are views schematically illustrating a magnetic body holding device according to yet another exemplary embodiment of the present disclosure;

FIGS. 5A to 5D are views schematically illustrating a magnetic body holding device according to still yet another exemplary embodiment of the present disclosure;

FIG. 6 is a view schematically illustrating a magnetic body holding device according to a further another exemplary embodiment of the present disclosure;

FIGS. 7A to 7D are views schematically illustrating a magnetic body holding device according to another further exemplary embodiment of the present disclosure;

FIG. 8 is a view schematically illustrating a magnetic body holding device according to still another further exemplary embodiment of the present disclosure;

FIGS. 9A to 9D are views schematically illustrating a magnetic body holding device according to yet another further exemplary embodiment of the present disclosure;

FIG. 10 is a view illustrating a state in which a sub-pole piece is mounted on the magnetic body holding device illustrated in FIG. 9A;

FIG. 11 is a bottom plan view illustrating the magnetic body holding device illustrated in FIG. 10 when viewed from a bottom side;

FIG. 12 is a view illustrating a modified exemplary embodiment of the magnetic body holding device illustrated in FIG. 10;

FIGS. 13A to 13C are views illustrating modified exemplary embodiments of an interaction surface of the magnetic body holding device illustrated in FIG. 9A;

FIG. 14 is a view illustrating a state in which covers are coupled to both ends of the pole pieces illustrated in FIG. 9A;

FIGS. 15A and 15B are views illustrating modified exemplary embodiments of a rotary magnet;

FIG. 16 is a view illustrating other modified exemplary embodiments of the rotary magnet;

FIG. 17 is a view schematically illustrating a magnetic body holding system according to an exemplary embodiment of the present disclosure;

FIGS. 18A and 18B are views illustrating a structure in which a detection sensor and a cam mounted on the magnetic body holding device illustrated in FIG. 9A operate in conjunction with each other; and

FIGS. 19A and 19B are views illustrating a structure in which a magnetic sensor for detecting a polarity of the magnetic body holding device illustrated in FIG. 9A is disposed.

### DETAILED DESCRIPTION OF THE EMBODIMENT

Hereinafter, various exemplary embodiments will be described in more detail with reference to the accompanying drawings. The exemplary embodiments disclosed in the present specification may be variously modified. Specific exemplary embodiments will be illustrated in the drawings and described in detail in the detailed description. However, the specific embodiments illustrated in the accompanying drawings are merely intended to facilitate understanding of various embodiments. Therefore, the technical spirit is not limited by the specific embodiments illustrated in the accompanying drawings, and the scope of the present disclosure should be understood as including all equivalents or substitutes included in the spirit and technical scope of the present disclosure.

In the present specification, in a case in which it is described that a first constituent element is formed “on” a second constituent element, this case does not exclude a configuration in which a third constituent element is interposed between the first and second constituent elements. That is, the first constituent element may be in direct contact with the second constituent element or the third constituent element may be interposed between the first and second constituent elements.

The terms including ordinal numbers such as ‘first’, ‘second’, and the like may be used to describe various constituent elements, but the constituent elements are not limited by the terms. These terms are used only to distinguish one constituent element from another constituent element.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof. When one constituent element is described as being “connected” or “coupled” to another constituent element, it should be understood that one constituent element can be connected or coupled directly to another constituent element, and an intervening constituent element can also be present between the constituent elements. When one constituent element is described as being “connected directly to” or “coupled directly to” another constituent element, it should be understood that no intervening constituent element is present between the constituent elements.

Meanwhile, the term “module” or “unit” used for a constituent element used in the present specification performs at least one function or operation. Further, the “module” or “unit” may perform the function or operation by hardware, software, or a combination of hardware and software. In addition, except for the “module” or “unit” that should be performed in specific hardware or performed by at least one processor, a plurality of “modules” or a plurality of “units” may be integrated into at least one module. Singular expressions include plural expressions unless clearly described as different meanings in the context.

In addition, in the description of the present disclosure, the specific descriptions of related well-known functions or configurations will be summarized or omitted when it is determined that the specific descriptions may unnecessarily obscure the subject matter of the present disclosure.

Hereinafter, exemplary embodiments of a magnetic body holding device according to the present disclosure will be described with reference to the accompanying drawings.

A magnetic body holding device according to the present disclosure refers to a device controlled to generate or not to generate magnetic force by changing magnetic characteristics on an interaction surface. The magnetic body holding device according to the present disclosure may be comprehensively used for a magnetic body holding apparatus, a power device, and the like. Hereinafter, an example in which the magnetic body holding device is used for the magnetic body holding apparatus will be described. However, the application of the magnetic body holding device is not limited thereto.

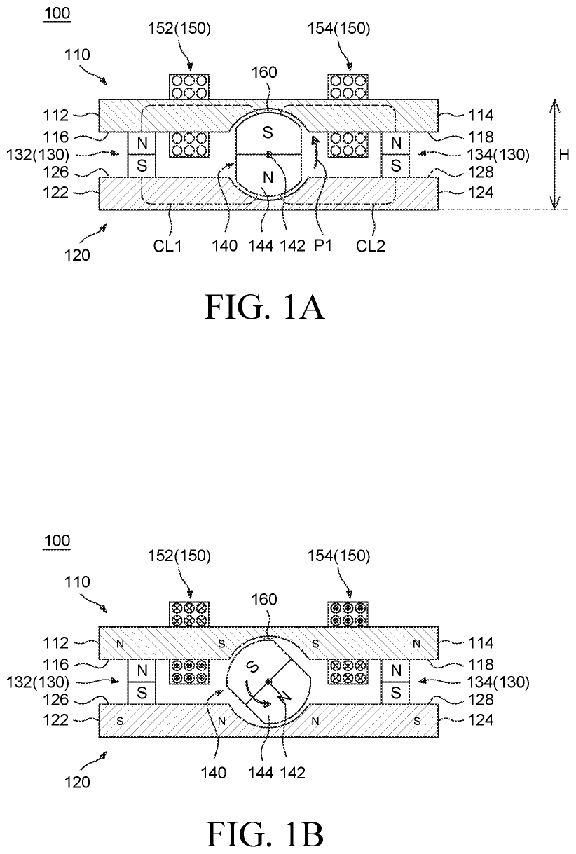

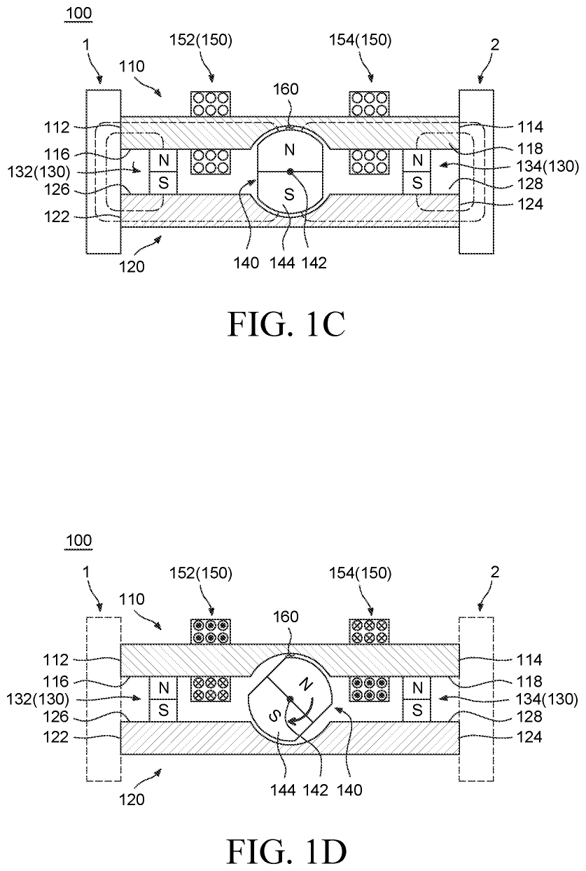

FIGS. 1A to 1D are views schematically illustrating a magnetic body holding device according to an exemplary embodiment of the present disclosure.

Referring to FIG. 1A to 1D, a magnetic body holding device 100 includes a first pole piece 110, a second pole piece 120, a pair of stationary magnets 130, a rotary magnet 140, and a pair of coils 150.

The first pole piece 110 is made of a ferromagnetic material such as iron capable of forming a path through which magnetism may flow. The first pole piece 110 includes a first interaction surface 112, a second interaction surface 114, a first support surface 116, and a second support surface 118.

The first interaction surface 112 is provided at one outer end of the first pole piece 110. When a magnetic flow is formed on the first interaction surface 112, a holding object 1 having magnetism may be held on the first interaction surface 112.

The second interaction surface 114 is provided at the other outer end of the first pole piece 110. When a magnetic flow is formed on the second interaction surface 114, a holding object 2 having magnetism may be held on the second interaction surface 114. That is, the second interaction surface 114 and the first interaction surface 112 are provided to hold different holding objects.

The first support surface 116 is provided on one portion of an inner surface of the first pole piece 110. The first support surface 116 is in contact with one end of a first stationary magnet 132 to support the first stationary magnet 132. FIGS. 1A to 1D illustrate the structure in which the first support surface 116 is in contact with an N-pole of the first stationary magnet 132, but a structure in which the first support surface 116 is in contact with an S-pole of the first stationary magnet 132 may also be applied.

The second support surface 118 is provided on the other portion of the inner surface of the first pole piece 110. The second support surface 118 is in contact with one end of a second stationary magnet 134 to support the second stationary magnet 134. FIGS. 1A to 1D illustrate the structure in which the second support surface 118 is in contact with an N-pole of the second stationary magnet 134, but a structure in which the second support surface 118 is in contact with an S-pole of the second stationary magnet 134 may also be applied.

The second pole piece 120 is disposed to be spaced apart from the first pole piece 110 in the vertical direction with the pair of stationary magnets 130 interposed therebetween.

The second pole piece 120 is made of a ferromagnetic material such as iron capable of forming a path through which magnetism may flow. The second pole piece 120 includes a third interaction surface 122, a fourth interaction surface 124, a third support surface 126, and a fourth support surface 128.

The third interaction surface 122 is provided at one outer end of the second pole piece 120. When a magnetic flow is formed on the third interaction surface 122, the holding object 1 having magnetism may be held on the third interaction surface 122. The third interaction surface 122 is disposed in parallel with the first interaction surface 112 in the vertical direction so as to be stably in contact with the holding object 1.

When the magnetic flow is formed on the first interaction surface 112 and the third interaction surface 122, the holding object 1 may come into contact with the first interaction surface 112 and the third interaction surface 122. When the holding object 1 is in contact with the first interaction surface 112 and the third interaction surface 122, the holding object 1 forms the magnetic flow together with the first pole piece 110 and the second pole piece 120 and is held on the magnetic body holding device 100.

The fourth interaction surface 124 is provided at the other outer end of the second pole piece 120. When a magnetic flow is formed on the fourth interaction surface 124, the holding object 2 having magnetism may be held on the fourth interaction surface 124. That is, the fourth interaction surface 124 and the third interaction surface 122 are provided to hold different holding objects. The fourth interaction surface 124 is disposed in parallel with the second interaction surface 112 in the vertical direction so as to be stably in contact with the holding object 2.

When the magnetic flow is formed on the second interaction surface 114 and the fourth interaction surface 124, the holding object 2 may come into contact with the second interaction surface 114 and the fourth interaction surface 124. When the holding object 2 is in contact with the second interaction surface 114 and the fourth interaction surface 124, the holding object 2 forms the magnetic flow together with the first pole piece 110 and the second pole piece 120 and is held on the magnetic body holding device 100.

The third support surface 126 is provided at one portion of an inner surface of the second pole piece 120. The third support surface 126 is disposed to face the first support surface 116.

The third support surface 126 is in contact with the other end of the first stationary magnet 132 to support the first stationary magnet 132. FIGS. 1A to 1D illustrate the structure in which the third support surface 126 is in contact with the S-pole of the first stationary magnet 132, but a structure in which the third support surface 126 is in contact with the N-pole of the first stationary magnet 132 may also be applied.

The fourth support surface 128 is provided on the other portion of the inner surface of the second pole piece 120. The fourth support surface 128 is disposed to face the second support surface 118.

The fourth support surface 128 is in contact with the other end of the second stationary magnet 134 to support the second stationary magnet 134. FIGS. 1A to 1D illustrate the structure in which the fourth support surface 128 is in contact with the S-pole of the second stationary magnet 134, but a structure in which the fourth support surface 128 is in contact with the N-pole of the second stationary magnet 134 may also be applied.

The second pole piece 120, together with the first pole piece 110, defines a receiving portion 160 that receives the rotary magnet 140. The receiving portion 160 receives the rotary magnet 140 and includes a rotation path P1 for the rotary magnet 140.

The pair of coils 150 may be wound around at least one of the first pole piece 110 and the second pole piece 120. FIG. 1A to 1D illustrate the structure in which both of the pair of coils 150 are wound around the first pole piece 110, but a structure in which both of the pair of coils 150 are wound around the second pole piece 120 or a structure in which the pair of coils 150 is wound around the first pole piece 110 and the second pole piece 120, respectively, may also be applied.

The pair of coils 150 includes a first coil 152 and a second coil 154. As illustrated in FIG. 1A to 1D, the first coil 152 is disposed between the first stationary magnet 132 and the rotary magnet 140, and the second coil 154 is disposed between the second stationary magnet 134 and the rotary magnet 140. The first coil 152 and the second coil 154 are disposed at both sides of the rotary magnet 140 with the rotary magnet 140 interposed therebetween.

When the current flows through the first coil 152 and the second coil 154, the magnetic flow is formed in a predetermined direction by Ampere's right-handed screw rule, and the N-poles and the S-poles are formed in the direction of the magnetic flow on the first pole piece 110 around which the first coil 152 and the second coil 154 are wound. That is, it can be seen that the first coil 152, the second coil 154, and one portion of the first pole piece 110 around which the first coil 152 and the second coil 154 are wound serve as an electromagnet.

The pair of stationary magnets 130 includes a first stationary magnet 132 and a second stationary magnet 134. The first stationary magnet 132 and the second stationary magnet 134 are permanent magnets.

The N-pole of the first stationary magnet 132 is disposed to be in contact with the first pole piece 110, and the S-pole of the first stationary magnet 132 is disposed to be in contact with the second pole piece 120. The first stationary magnet 132 may be disposed to be closer to the first interaction surface 112 and the third interaction surface 122 than the rotary magnet 140 and a rotation center Cl of the rotary magnet 140.

The N-pole of the second stationary magnet 134 is disposed to be in contact with the first pole piece 110, and the S-pole of the second stationary magnet 134 is disposed to be in contact with the second pole piece 120. The second stationary magnet 134 may be disposed to be closer to the second interaction surface 114 and the fourth interaction surface 124 than the rotary magnet 140 and the rotation center Cl of the rotary magnet 140.

The rotary magnet 140 includes a permanent magnet 144 and a rotary shaft 142 disposed rotatably. The permanent magnet 144 is disposed to be rotatable about the rotary shaft 142.

The rotary magnet 140 is disposed to be rotatable between a first position (see FIG. 1A) at which the S-pole of the rotary magnet 140 is adjacent to the first pole piece 110 and magnetically connected to the first pole piece 110 and the N-pole of the rotary magnet 140 is adjacent to the second pole piece 120 and magnetically connected to the second pole piece 120 and a second position (see FIG. 1C) at which the N-pole of the rotary magnet 140 is adjacent to the first pole piece 110 and magnetically connected to the first pole piece 110 and the S-pole of the rotary magnet 140 is adjacent to the second pole piece 120 and magnetically connected to the second pole piece 120.

The configuration in which the rotary magnet 140 is “magnetically connected” to the first pole piece 110 or the second pole piece 120 includes a case in which the rotary magnet 140 is spaced apart from the first pole piece 110 or the second pole piece 120 to the extent that the magnetic flow may be formed on the first pole piece 110 or the second pole piece 120 by the rotary magnet 140 even though the rotary magnet 140 is not physically in direct contact with the first pole piece 110 or the second pole piece 120.

For example, it can be said that the rotary magnet 140 is magnetically connected to the first pole piece 110 or the second pole piece 120 when the magnetic flow having intensity, which is equal to or higher than A % of intensity of the magnetic flow generated when the rotary magnet 140 comes into contact with the first pole piece 110 or the second pole piece 120, is formed on the first pole piece 110 or the second pole piece 120. In this case, A may be 80, 70, 60, 50, 40, 30, 20, or the like.

The rotary magnet 140 is disposed to be spaced apart from the pair of stationary magnets 130 in a horizontal direction. Therefore, an overall height H of the magnetic body holding device 100 may be reduced, the magnetic body holding device 100 may be compact, and high holding force may be maintained.

Hereinafter, a principle of holding the holding objects 1 and 2, which are the magnetic bodies, or releasing the holding objects 1 and 2 will be described with reference to FIGS. 1A to 1D.

First, referring to FIG. 1A, when no power is applied to the first coil 152 and the second coil 154 and thus no current flows, a portion of the first pole piece 110 being in contact with the N-pole of the first stationary magnet 132, that is, the portion of the first pole piece 110, which is adjacent to the N-pole of the first stationary magnet 132, is magnetized as the S-pole, and a portion of the first pole piece 110, which is relatively distant from the N-pole of the first stationary magnet 132, that is, the portion of the first pole piece 110, which is adjacent to the rotary magnet 140, is magnetized as the N-pole.

A portion of the second pole piece 120 being in contact with the S-pole of the first stationary magnet 132, that is, the portion of the second pole piece 120, which is adjacent to the S-pole of the first stationary magnet 132, is magnetized as the N-pole, and a portion of the second pole piece 120, which is relatively distant from the S-pole of the first stationary magnet 132, that is, the portion of the second pole piece 120, which is adjacent to the rotary magnet 140, is magnetized as the S-pole.

Likewise, a portion of the first pole piece 110 being in contact with the N-pole of the second stationary magnet 134, that is, the portion of the first pole piece 110, which is adjacent to the N-pole of the second stationary magnet 134, is magnetized as the S-pole, and a portion of the first pole piece 110, which is relatively distant from the N-pole of the second stationary magnet 134, that is, the portion of the first pole piece 110, which is adjacent to the rotary magnet 140, is magnetized as the N-pole.

A portion of the second pole piece 120 being in contact with the S-pole of the second stationary magnet 134, that is, the portion of the second pole piece 120, which is adjacent to the S-pole of the second stationary magnet 134, is magnetized as the N-pole, and a portion of the second pole piece 120, which is relatively distant from the S-pole of the second stationary magnet 134, that is, the portion of the second pole piece 120, which is adjacent to the rotary magnet 140, is magnetized as the S-pole.

Therefore, the rotary magnet 140 is rotated and disposed at the first position at which the S-pole of the rotary magnet 140 is adjacent to the first pole piece 110 and magnetically connected to the first pole piece 110 and the N-pole of the rotary magnet 140 is adjacent to the second pole piece 120 and magnetically connected to the second pole piece 120.

When the rotary magnet 140 is rotated and disposed at the first position, one magnetic closed loop CL1 is formed along the first stationary magnet 132, the first pole piece 110, the rotary magnet 140, and the second pole piece 120, as indicated by the dotted line illustrated in FIG. 1A. In addition, when the rotary magnet 140 is rotated and disposed at the first position, the other magnetic closed loop CL2 is formed along the second stationary magnet 134, the first pole piece 110, the rotary magnet 140, and the second pole piece 120.

Because no magnetic flow is formed in a direction toward the first interaction surface 112, the second interaction surface 114, the third interaction surface 122, and the fourth interaction surface 124 in the state in which the rotary magnet 140 is rotated and disposed at the first position, the holding objects 1 and 2 cannot be held on the first interaction surface 112 and the third interaction surface 122 or on the second interaction surface 114 and the fourth interaction surface 124.

When the first coil 152 and the second coil 154 are controlled so that the current flows through the first coil 152 and the second coil 154 as illustrated in FIG. 1B, the N-pole is formed on the portion of the first pole piece 110 which is adjacent to the first interaction surface 112, and the S-pole is formed on the portion of the second pole piece 120 which is adjacent to the third interaction surface 122.

In addition, the S-pole is formed on the portion of the first pole piece 110 which is adjacent to the rotary magnet 140, and the N-pole is formed on the portion of the second pole piece 120 which is adjacent to the rotary magnet 140.

Likewise, when the first coil 152 and the second coil 154 are controlled so that the current flows through the first coil 152 and the second coil 154 as illustrated in FIG. 1B, the N-pole is formed on the portion of the first pole piece 110 which is adjacent to the second interaction surface 114, and the S-pole is formed on the portion of the second pole piece 120 which is adjacent to the fourth interaction surface 124.

When a sufficient current flows through the coil 150, the rotary magnet 140 receives repulsive force from the first pole piece 110, and the rotary magnet 140 is rotated.

When the rotary magnet 140 is rotated by 180 degrees from the first position and disposed at the second position as illustrated in FIG. 1C, the N-pole of the rotary magnet 140 is adjacent to the first pole piece 110 and magnetically connected to the first pole piece 110, and the S-pole of the rotary magnet 140 is adjacent to the second pole piece 120 and magnetically connected to the second pole piece 120.

When the rotary magnet 140 is rotated and disposed at the second position, the magnetic flow is formed on the first interaction surface 112, the second interaction surface 114, the third interaction surface 122, and the fourth interaction surface 124, and the magnetic flow may form the magnetic closed loop together with another magnetic body. That is, the magnetic flow diverges through the first interaction surface 112, the second interaction surface 114, the third interaction surface 122, and the fourth interaction surface 124. In this case, the “divergence of the magnetic flow” includes both a case in which the magnetic flow is formed to the outside from the first interaction surface 112, the second interaction surface 114, the third interaction surface 122, and the fourth interaction surface 124 and a case in which the magnetic flow is formed from the outside to the first interaction surface 112, the second interaction surface 114, the third interaction surface 122, and the fourth interaction surface 124.

Therefore, when the holding object 1 having magnetism comes into contact with the first interaction surface 112 and the third interaction surface 122, the holding object 1 forms the magnetic closed loop, as illustrated in FIG. 1C, together with the rotary magnet 140, the first pole piece 110, and the second pole piece 120, and the holding object 1 is held on the first interaction surface 112 and the third interaction surface 122 at one side of the magnetic body holding device 100.

In addition, when the holding object 2 having magnetism comes into contact with the second interaction surface 114 and the fourth interaction surface 124, the holding object 2 forms the magnetic closed loop, as illustrated in FIG. 1C, together with the rotary magnet 140, the first pole piece 110, and the second pole piece 120, and the holding object 2 is held on the second interaction surface 114 and the fourth interaction surface 124 at the other side of the magnetic body holding device 100.

Because the first stationary magnet 132 and the second stationary magnet 134 cannot form the magnetic flow together with the rotary magnet 140 in the state in which the rotary magnet 140 is disposed at the second position, the first stationary magnet 132 and the second stationary magnet 134 form other magnetic closed loops together with the holding objects 1 and 2.

As described above, since the holding objects 1 and 2 form different magnetic closed loops together with the rotary magnet 140, the first stationary magnet 132, and the second stationary magnet 134, the holding objects 1 and 2 may be stably held by the magnetic body holding device 100.

When the magnetic closed loops are formed as illustrated in FIG. 1C, the magnetic closed loops are maintained even though the voltage applied to the first coil 152 and the second coil 154 is eliminated, and as a result, the holding objects 1 and 2 remain held.

When the first coil 152 and the second coil 154 are controlled, as illustrated in FIG. 1D, in the state in which the rotary magnet 140 is disposed at the second position so that the current flows in a direction opposite to the direction of the flow of the current illustrated in FIG. 1B, the rotary magnet 140 is rotated back to the first position and forms the magnetic closed loops CL1 and CL2 together with the first stationary magnet 132 and the second stationary magnet 134, respectively, as illustrated in FIG. 1A, such that the holding objects 1 and 2 may be separated from the magnetic body holding device 100.

In the exemplary embodiment illustrated in FIGS. 1A to 1D, there has been described the example in which the first coil 152 and the second coil 154 are controlled so that the current flows through both the first coil 152 and the second coil 154 or no current flows through the first coil 152 and the second coil 154. However, the first coil 152 and the second coil 154 may be controlled so that the current flows through the first coil 152, and no current flows through the second coil 154, or the first coil 152 and the second coil 154 may be controlled so that no current flows through the first coil 152, and the current flows through the second coil 154.

Hereinafter, a magnetic body holding device 100′ according to another exemplary embodiment of the present disclosure will be described. A description of parts identical to the above-mentioned parts of the magnetic body holding device 100 according to another exemplary embodiment of the present disclosure will be omitted, and only parts different from the above-mentioned parts of the magnetic body holding device 100 will be described.

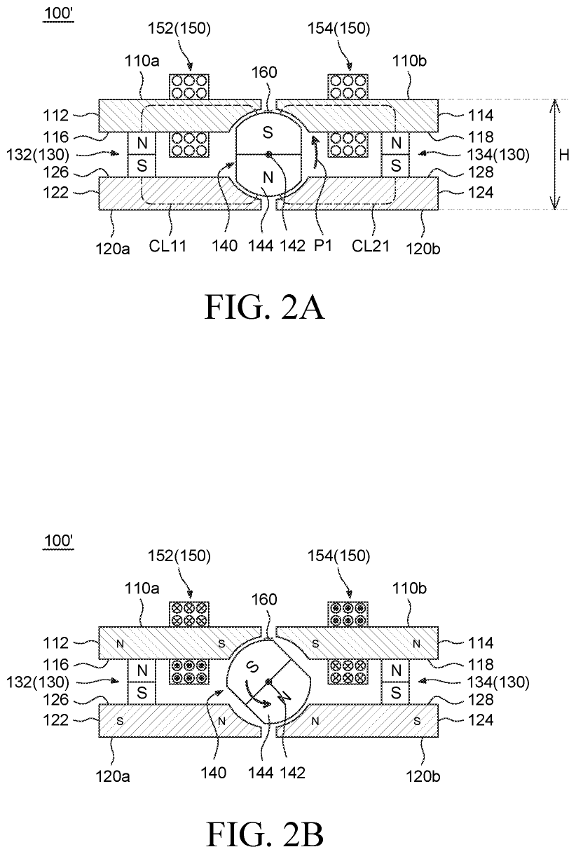

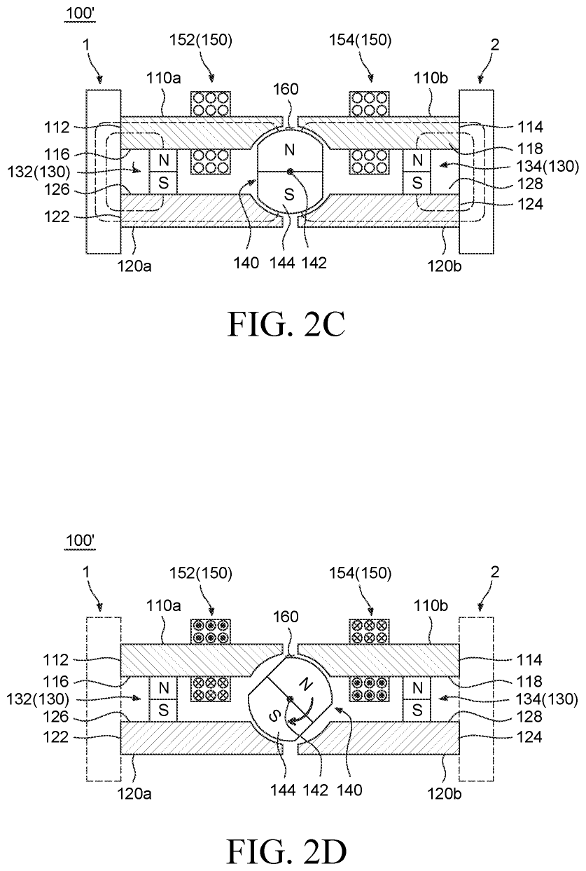

FIGS. 2A to 2D are views schematically illustrating the magnetic body holding device according to another exemplary embodiment of the present disclosure.

The magnetic body holding device 100′ illustrated in FIGS. 2A to 2D is an exemplary embodiment in which the first pole piece 110 and the second pole piece 120 of the magnetic body holding device 100 illustrated in FIGS. 1A to 1D are divided into four pole pieces.

That is, the magnetic body holding device 100′ illustrated in FIGS. 2A to 2D includes a first pole piece 110a, a second pole piece 110b, a third pole piece 120a, and a fourth pole piece 120b.

Therefore, the first interaction surface 112 and the first support surface 116 are included in the first pole piece 110a, the second interaction surface 114 and the second support surface 118 are included in the second pole piece 110b, the third interaction surface 122 and the third support surface 126 are included in the third pole piece 120a, and the fourth interaction surface 124 and the fourth support surface 128 are included in the fourth pole piece 120b.

The N-pole of the first stationary magnet 132 comes into contact with the first support surface 116 of the first pole piece 110a, and the S-pole of the first stationary magnet 132 comes into contact with the third support surface 126 of the third pole piece 120a. The N-pole of the second stationary magnet 134 comes into contact with the second support surface 118 of the second pole piece 110b, and the S-pole of the second stationary magnet 134 comes into contact with the fourth support surface 128 of the fourth pole piece 120b.

The first coil 152 is wound around the first pole piece 110a, and the second coil 154 is wound around the second pole piece 110b.

FIGS. 2A to 2D illustrate the structure in which the first coil 152 is wound around the first pole piece 110a and the second coil 154 is wound around the second pole piece 110b. However, a structure in which the first coil 152 is wound around the first pole piece 110a and the second coil 154 is wound around the third pole piece 120a, a structure in which the first coil 152 is wound around the first pole piece 110a and the second coil 154 is wound around the fourth pole piece 120b, a structure in which the second coil 154 is wound around the second pole piece 110b and the first coil 110a is wound around the third pole piece 120a, a structure in which the second coil 154 is wound around the second pole piece 110b and the first coil 110a is wound around the fourth pole piece 120a, and a structural in which the first coil 152 is wound around the third pole piece 120a and the second coil 154 is wound around the fourth pole piece 120b may also be applied.

In the magnetic body holding device 100 illustrated in FIGS. 1A to 1D, the receiving portion 160 for receiving the rotary magnet 140 is formed by the first pole piece 110 and the second pole piece 120. However, in the magnetic body holding device 100′ illustrated in FIGS. 2A to 2D, the receiving portion 160 is formed by the first pole piece 110a, the second pole piece 110b, the third pole piece 120a, and the fourth pole piece 120b.

A principle of holding the holding objects 1 and 2, which are the magnetic bodies, or releasing the holding objects 1 and 2 by the magnetic body holding device 100′ illustrated in FIGS. 2A to 2D is identical to the principle of holding the holding objects 1 and 2 or releasing the holding objects 1 and 2 by the magnetic body holding device 100 illustrated in FIGS. 1A to 1D.

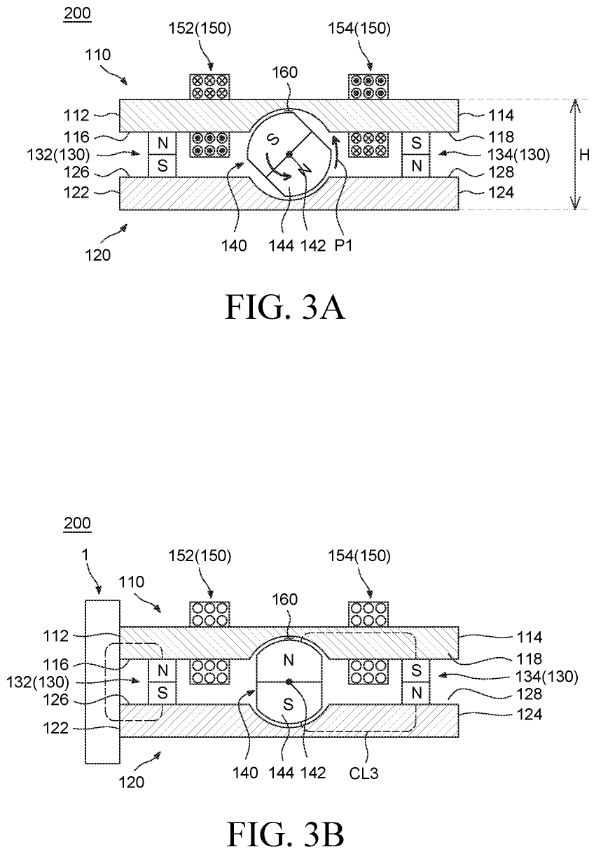

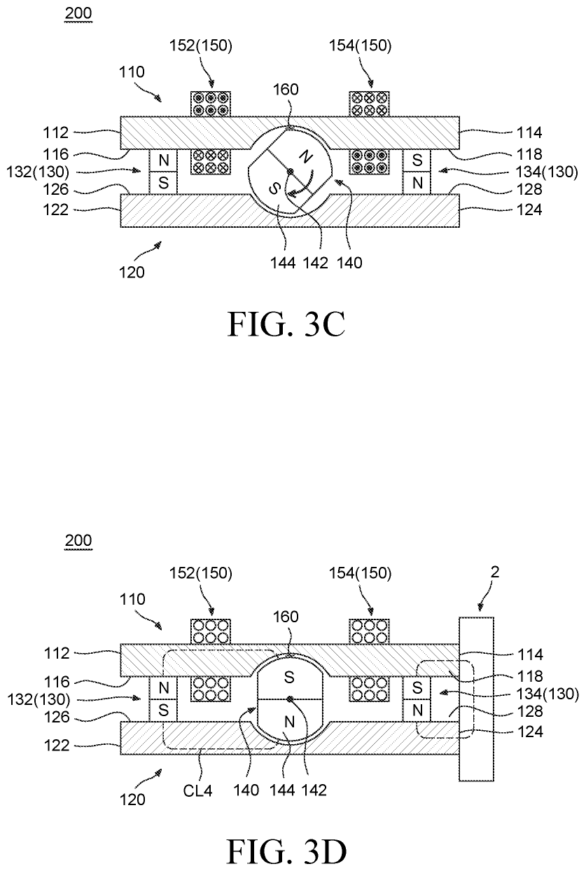

FIGS. 3A to 3D are views schematically illustrating a magnetic body holding device according to still another exemplary embodiment of the present disclosure.

The magnetic body holding device 200 illustrated in FIGS. 3A to 3D is an exemplary embodiment in which only positions of the N-pole and the S-pole of the second stationary magnet 134 of the magnetic body holding device 100 illustrated in FIGS. 1A to 1D are changed conversely.

That is, the magnetic body holding device 200 illustrated in FIGS. 3A to 3D is structured such that the N-pole of the second stationary magnet 134 is supported by the second pole piece 120, and the S-pole of the second stationary magnet 134 is supported by the first pole piece 110.

In addition, the constituent elements included in the magnetic body holding device 200 illustrated in FIGS. 3A to 3D are identical to the constituent elements included in the magnetic body holding device 100 illustrated in FIGS. 1A to 1D, and as a result, the same constituent elements are denoted by the same reference numerals, and specific descriptions thereof will be omitted.

Hereinafter, a principle of holding or releasing the holding objects 1 and 2, which are the magnetic bodies, will be described with reference to FIGS. 3A to 3D.

As illustrated in FIG. 3A, when a sufficient current flows through the first coil 152 and the second coil 154, the rotary magnet 140 receives repulsive force from the first pole piece 110, and the rotary magnet 140 is rotated.

When the rotary magnet 140 is rotated and disposed at the first position as illustrated in FIG. 2B, the N-pole of the rotary magnet 140 is adjacent to the first pole piece 110 and magnetically connected to the first pole piece 110, and the S-pole of the rotary magnet 140 is adjacent to the second pole piece 120 and magnetically connected to the second pole piece 120.

When the rotary magnet 140 is disposed at the first position, the magnetic flow is formed on the first interaction surface 112 and the third interaction surface 122 by the first stationary magnet 132, and the magnetic flow may form the magnetic closed loop together with another magnetic body. That is, the magnetic flow diverges through the first interaction surface 112 and the third interaction surface 122.

Therefore, when the holding object 1 having magnetism comes into contact with the first interaction surface 112 and the third interaction surface 122, the holding object 1, together with the first stationary magnet 132, forms the magnetic closed loop as illustrated in FIG. 2B, and the holding object 1 is held on the first interaction surface 112 and the third interaction surface 122 at one side of the magnetic body holding device 200.

When the magnetic closed loops are formed as illustrated in FIG. 3B, the magnetic closed loops are maintained even though the voltage applied to the first coil 152 and the second coil 154 is eliminated, and as a result, the holding object 1 remains held.

In addition, in the state in which the rotary magnet 140 is disposed at the first position, one magnetic closed loop CL3 is formed along the second stationary magnet 134, the second pole piece 120, the rotary magnet 140, and the first pole piece 110.

Therefore, because no magnetic flow is formed in the direction toward the second interaction surface 114 and the fourth interaction surface 124, the holding object 2 cannot be held on the second interaction surface 114 and the fourth interaction surface 124.

As illustrated in FIG. 3C, when a sufficient current flows through the first coil 152 and the second coil 154 in the direction opposite to the direction illustrated in FIG. 3A in the state in which the rotary magnet 140 is disposed at the first position, the rotary magnet 140 receives the repulsive force again from the first pole piece 110, and the rotary magnet 140 is rotated.

When the rotary magnet 140 is rotated by 180 degrees from the first position and positioned at the second position as illustrated in FIG. 3D, the N-pole of the rotary magnet 140 is adjacent to the second pole piece 120 and magnetically connected to the second pole piece 120, and the S-pole of the rotary magnet 140 is adjacent to the first pole piece 110 and magnetically connected to the first pole piece 110.

When the rotary magnet 140 is disposed at the second position, the magnetic flow is formed on the second interaction surface 114 and the fourth interaction surface 124 by the second stationary magnet 134, and the magnetic flow may form the magnetic closed loop together with another magnetic body. That is, the magnetic flow diverges through the second interaction surface 114 and the fourth interaction surface 124.

Therefore, when the holding object 2 having magnetism comes into contact with the second interaction surface 114 and the fourth interaction surface 124, the holding object 2, together with the second stationary magnet 134, forms the magnetic closed loop as illustrated in FIG. 3D, and the holding object 2 is held on the second interaction surface 114 and the fourth interaction surface 124 at one side of the magnetic body holding device 200.

When the magnetic closed loops are formed as illustrated in FIG. 3D, the magnetic closed loops are maintained even though the voltage applied to the first coil 152 and the second coil 154 is eliminated, and as a result, the holding object 2 remains held.

In addition, in the state in which the rotary magnet 140 is disposed at the second position, one magnetic closed loop CL4 is formed along the first stationary magnet 132, the first pole piece 110, the rotary magnet 140, and the second pole piece 120.

Therefore, because no magnetic flow is formed in the direction toward the first interaction surface 112 and the third interaction surface 122, the holding object 1 cannot be held on the first interaction surface 112 and the third interaction surface 122.

In the exemplary embodiment illustrated in FIGS. 3A to 3D, there has been described the example in which the first coil 152 and the second coil 154 are controlled so that the current flows through both the first coil 152 and the second coil 154 or no current flows through the first coil 152 and the second coil 154. However, the first coil 152 and the second coil 154 may be controlled so that the current flows through the first coil 152, and no current flows through the second coil 154, or the first coil 152 and the second coil 154 may be controlled so that no current flows through the first coil 152, and the current flows through the second coil 154.

Hereinafter, a magnetic body holding device 200′ according to yet another exemplary embodiment of the present disclosure will be described. A description of parts identical to the above-mentioned parts of the magnetic body holding device 100′ according to another exemplary embodiment of the present disclosure will be omitted, and only parts different from the above-mentioned parts of the magnetic body holding device 100 will be described.

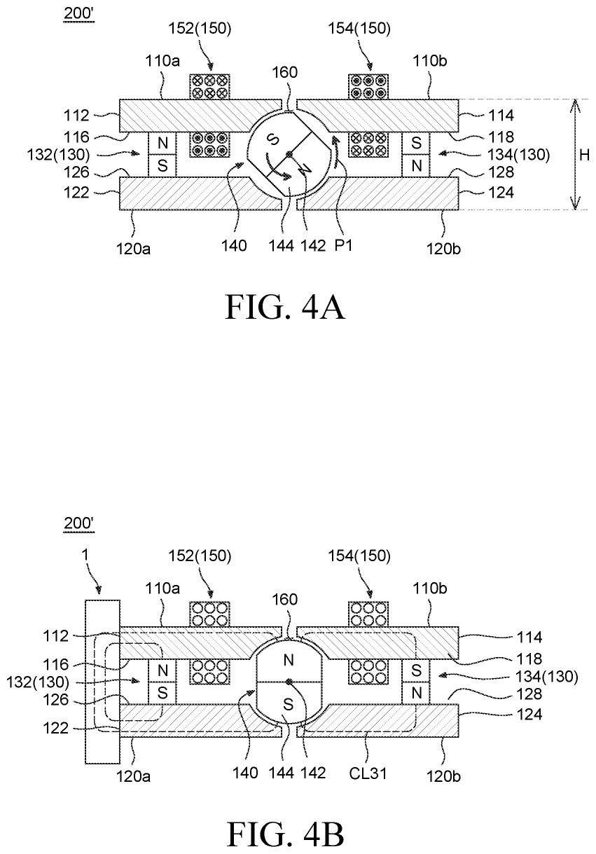

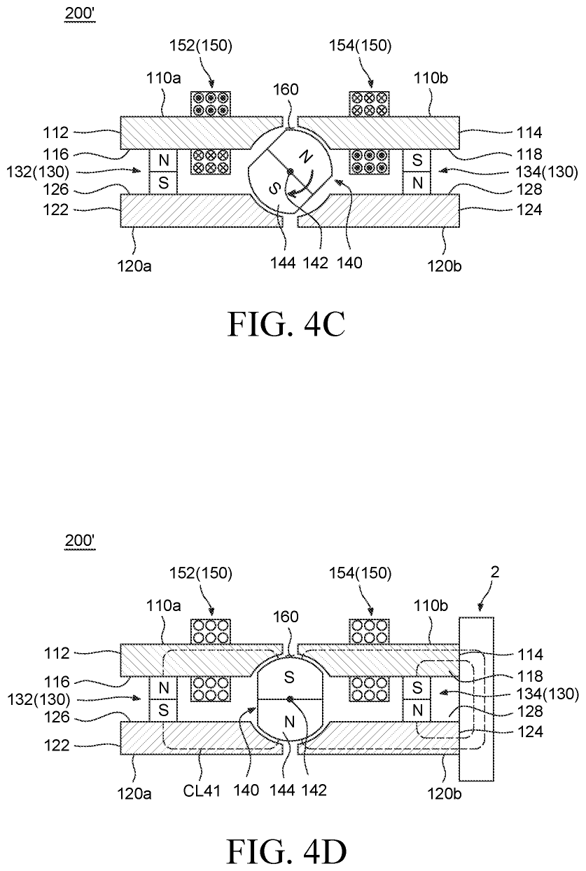

FIGS. 4A to 4D are views schematically illustrating the magnetic body holding device according to yet another exemplary embodiment of the present disclosure.

The magnetic body holding device 200′ illustrated in FIGS. 4A to 4D is an exemplary embodiment in which only positions of the N-pole and the S-pole of the second stationary magnet 134 of the magnetic body holding device 100′ illustrated in FIGS. 2A to 2D are changed conversely.

That is, the magnetic body holding device 200′ illustrated in FIGS. 4A to 4D is structured such that the N-pole of the second stationary magnet 134 is supported by the fourth pole piece 120b, and the S-pole of the second stationary magnet 134 is supported by the second pole piece 110b.

In addition, the constituent elements included in the magnetic body holding device 200′ illustrated in FIGS. 4A to 4D are identical to the constituent elements included in the magnetic body holding device 100′ illustrated in FIGS. 2A to 2D, and as a result, the same constituent elements are denoted by the same reference numerals, and specific descriptions thereof will be omitted.

A principle of holding the holding objects 1 and 2, which are the magnetic bodies, or releasing the holding objects 1 and 2 by the magnetic body holding device 200′ illustrated in FIGS. 4A to 4D is identical to the principle of holding the holding objects 1 and 2 or releasing the holding objects 1 and 2 by the magnetic body holding device 200 illustrated in FIGS. 3A to 3D.

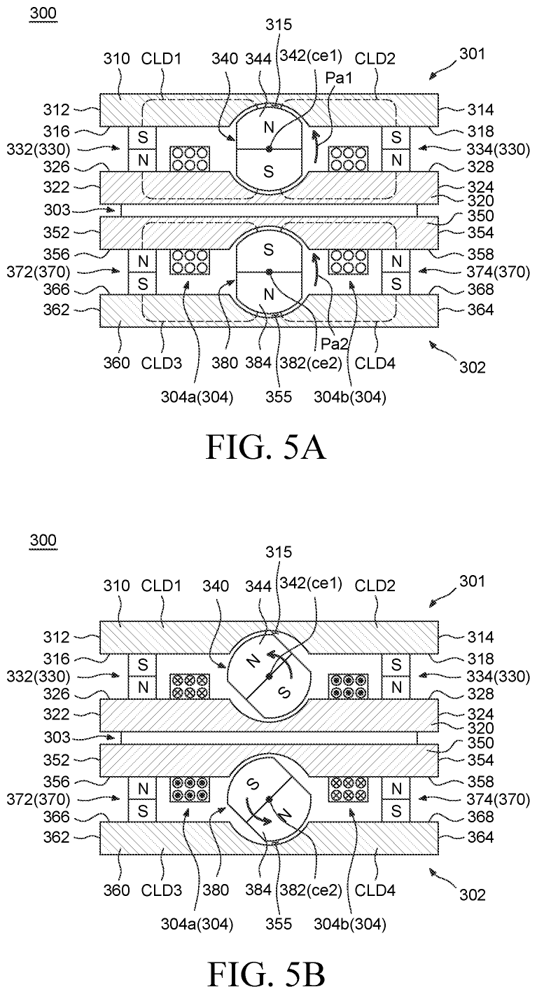

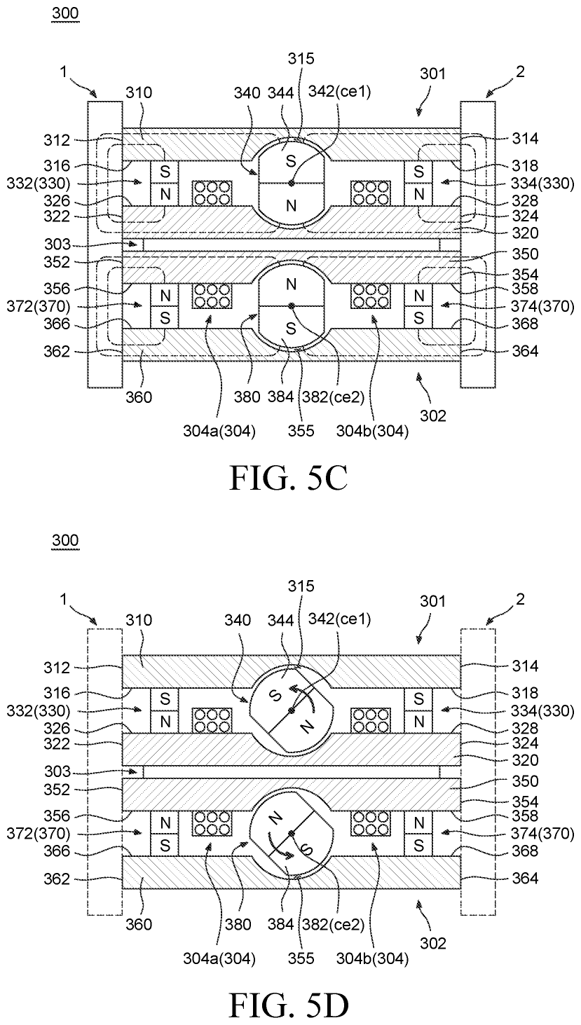

FIGS. 5A to 5D are views schematically illustrating a magnetic body holding device according to still yet another exemplary embodiment of the present disclosure.

Referring to FIGS. 5A to 5D, a magnetic body holding device 300 includes a first magnetic body holding module 301, a second magnetic body holding module 302, a diamagnetic body 303 disposed between the first magnetic body holding module 301 and the second magnetic body holding module 302, and a pair of coils 304 shared by the first magnetic body holding module 301 and the second magnetic body holding module 302.

The first magnetic body holding module 301 includes a first pole piece 310, a second pole piece 320, a pair of stationary magnets 330, and a first rotary magnet 340.

The first pole piece 310 is made of a ferromagnetic material such as iron capable of forming a path through which magnetism may flow. The first pole piece 310 includes a first interaction surface 312, a second interaction surface 314, a first support surface 316, and a second support surface 318.

The first interaction surface 312 is provided at one outer end of the first pole piece 310. When a magnetic flow is formed on the first interaction surface 312, the holding object 1 having magnetism may be held on the first interaction surface 312.

The second interaction surface 314 is provided at the other outer end of the first pole piece 310. When a magnetic flow is formed on the second interaction surface 314, the holding object 2 having magnetism may be held on the second interaction surface 314. That is, the second interaction surface 314 and the first interaction surface 312 are provided to hold different holding objects.

The first support surface 316 is provided on one portion of an inner surface of the first pole piece 310. The first support surface 316 is in contact with one end of a first stationary magnet 332 to support the first stationary magnet 332. FIGS. 5A to 5D illustrate the structure in which the first support surface 316 is in contact with the S-pole of the first stationary magnet 332, but a structure in which the first support surface 316 is in contact with the N-pole of the first stationary magnet 332 may also be applied.

The second support surface 318 is provided on the other portion of the inner surface of the first pole piece 310. The second support surface 318 is in contact with one end of a second stationary magnet 334 to support the second stationary magnet 334. FIGS. 5A to 5D illustrate the structure in which the second support surface 318 is in contact with the S-pole of the second stationary magnet 334, but a structure in which the second support surface 318 is in contact with the N-pole of the second stationary magnet 334 may also be applied.

The second pole piece 320 is disposed to be spaced apart from the first pole piece 310 in the vertical direction with the pair of stationary magnets 330 interposed therebetween.

The second pole piece 320 is made of a ferromagnetic material such as iron capable of forming a path through which magnetism may flow. The second pole piece 320 includes a third interaction surface 322, a fourth interaction surface 324, a third support surface 326, and a fourth support surface 328.

The third interaction surface 322 is provided at one outer end of the second pole piece 320. When a magnetic flow is formed on the third interaction surface 322, the holding object 1 having magnetism may be held on the third interaction surface 322. The third interaction surface 322 is disposed in parallel with the first interaction surface 312 in the vertical direction so as to be stably in contact with the holding object 1.

When the magnetic flow is formed on the first interaction surface 312 and the third interaction surface 322, the holding object 1 may come into contact with the first interaction surface 312 and the third interaction surface 322. When the holding object 1 is in contact with the first interaction surface 312 and the third interaction surface 322, the holding object 1 forms the magnetic flow together with the first pole piece 310 and the second pole piece 320 and is held on the magnetic body holding device 300.

The fourth interaction surface 324 is provided at the other outer end of the second pole piece 320. When a magnetic flow is formed on the fourth interaction surface 324, the holding object 2 having magnetism may be held on the fourth interaction surface 324. That is, the fourth interaction surface 324 and the third interaction surface 322 are provided to hold different holding objects. The fourth interaction surface 324 is disposed in parallel with the second interaction surface 312 in the vertical direction so as to be stably in contact with the holding object 2.

When the magnetic flow is formed on the second interaction surface 314 and the fourth interaction surface 324, the holding object 2 may come into contact with the second interaction surface 314 and the fourth interaction surface 324. When the holding object 2 is in contact with the second interaction surface 314 and the fourth interaction surface 324, the holding object 2 forms the magnetic flow together with the first pole piece 310 and the second pole piece 320 and is held on the magnetic body holding device 300.

The third support surface 326 is provided at one portion of an inner surface of the second pole piece 320. The third support surface 326 is disposed to face the first support surface 316.

The third support surface 326 is in contact with the other end of the first stationary magnet 332 to support the first stationary magnet 332. FIGS. 5A to 5D illustrate the structure in which the third support surface 326 is in contact with the N-pole of the first stationary magnet 332, but a structure in which the third support surface 326 is in contact with the S-pole of the first stationary magnet 332 may also be applied.

The fourth support surface 328 is provided on the other portion of the inner surface of the second pole piece 320. The fourth support surface 328 is disposed to face the second support surface 318.

The fourth support surface 328 is in contact with the other end of the second stationary magnet 334 to support the second stationary magnet 334. FIGS. 5A to 5D illustrate the structure in which the fourth support surface 328 is in contact with the N-pole of the second stationary magnet 334, but a structure in which the fourth support surface 328 is in contact with the S-pole of the second stationary magnet 334 may also be applied.

The second pole piece 320, together with the first pole piece 310, defines a first receiving portion 315 that receives the first rotary magnet 340. The first receiving portion 315 receives the first rotary magnet 340 and includes a rotation path Pa1 for the first rotary magnet 340.

The pair of stationary magnets 330 includes a first stationary magnet 332 and a second stationary magnet 334. The first stationary magnet 332 and the second stationary magnet 334 are permanent magnets.

The S-pole of the first stationary magnet 332 is disposed to be in contact with the first pole piece 310, and the N-pole of the first stationary magnet 332 is disposed to be in contact with the second pole piece 320. The first stationary magnet 332 may be disposed to be closer to the first interaction surface 312 and the third interaction surface 322 than the first rotary magnet 340 and a rotation center Ce1 of the first rotary magnet 340.

The S-pole of the second stationary magnet 334 is disposed to be in contact with the first pole piece 310, and the N-pole of the second stationary magnet 334 is disposed to be in contact with the second pole piece 320. The second stationary magnet 334 may be disposed to be closer to the second interaction surface 314 and the fourth interaction surface 324 than the first rotary magnet 340 and the rotation center Ce1 of the first rotary magnet 340.

The first rotary magnet 340 includes a first permanent magnet 344 and a first rotary shaft 342 disposed rotatably. The first permanent magnet 344 is disposed to be rotatable about the first rotary shaft 342.

The first rotary magnet 340 is disposed to be rotatable between a first position (see FIG. 5A) at which the N-pole of the first rotary magnet 340 is adjacent to the first pole piece 310 and magnetically connected to the first pole piece 310 and the S-pole of the first rotary magnet 340 is adjacent to the second pole piece 320 and magnetically connected to the second pole piece 320 and a second position (see FIG. 5C) at which the S-pole of the first rotary magnet 340 is adjacent to the first pole piece 310 and magnetically connected to the first pole piece 310 and the N-pole of the first rotary magnet 340 is adjacent to the second pole piece 320 and magnetically connected to the second pole piece 320.

The configuration in which the first rotary magnet 340 is “magnetically connected” to the first pole piece 310 or the second pole piece 320 includes a case in which the first rotary magnet 340 is spaced apart from the first pole piece 310 or the second pole piece 320 to the extent that the magnetic flow may be formed on the first pole piece 310 or the second pole piece 320 by the first rotary magnet 340 even though the first rotary magnet 340 is not physically in direct contact with the first pole piece 310 or the second pole piece 320.

For example, it can be said that the first rotary magnet 340 is magnetically connected to the first pole piece 310 or the second pole piece 320 when the magnetic flow having intensity, which is equal to or higher than A % of intensity of the magnetic flow generated when the first rotary magnet 340 comes into contact with the first pole piece 310 or the second pole piece 320, is formed on the first pole piece 310 or the second pole piece 320. In this case, A may be 80, 70, 60, 50, 40, 30, 20, or the like.

The first rotary magnet 340 is disposed to be spaced apart from the pair of stationary magnets 330 in the horizontal direction.

The second magnetic body holding module 302 is disposed to be spaced apart from the first magnetic body holding module 301 in the vertical direction. The diamagnetic body 303 is disposed between the first magnetic body holding module 301 and the second magnetic body holding module 302 to prevent magnetic interference that may occur between the first magnetic body holding module 301 and the second magnetic body holding module 302.

The second magnetic body holding module 302 and the first magnetic body holding module 301 are symmetrically disposed with respect to the diamagnetic body 303.

The second magnetic body holding module 302 includes a third pole piece 350, a fourth pole piece 360, a pair of stationary magnets 370, and a second rotary magnet 380.

The third pole piece 350 is made of a ferromagnetic material such as iron capable of forming a path through which magnetism may flow. The third pole piece 350 includes a fifth interaction surface 352, a sixth interaction surface 354, a fifth support surface 356, a sixth support surface 358.

The fifth interaction surface 352 is provided at one outer end of the third pole piece 350. When a magnetic flow is formed on the fifth interaction surface 352, the holding object 1 having magnetism may be held on the fifth interaction surface 352.

The sixth interaction surface 354 is provided at the other outer end of the third pole piece 350. When a magnetic flow formed on the sixth interaction surface 354, the holding object 2 having magnetism may be held on the sixth interaction surface 354. That is, the sixth interaction surface 354 and the fifth interaction surface 352 are provided to hold different holding objects.

The fifth support surface 356 is provided on one portion of an inner surface of the third pole piece 350. The fifth support surface 356 is in contact with one end of a third stationary magnet 372 to support the third stationary magnet 372. FIGS. 5A to 5D illustrate the structure in which the fifth support surface 356 is in contact with the N-pole of the third stationary magnet 372, but a structure in which the fifth support surface 356 is in contact with the S-pole of the third stationary magnet 372 may also be applied.

The sixth support surface 358 is provided on the other portion of the inner surface of the third pole piece 350. The sixth support surface 358 is in contact with one end of a fourth stationary magnet 374 to support the fourth stationary magnet 374. FIGS. 5A to 5D illustrate the structure in which the sixth support surface 358 is in contact with the N-pole of the fourth stationary magnet 374, but a structure in which the sixth support surface 358 is in contact with the S-pole of the fourth stationary magnet 374 may also be applied.

The fourth pole piece 360 is disposed to be spaced apart from the third pole piece 350 in the vertical direction with the pair of stationary magnets 370 interposed therebetween.

The fourth pole piece 360 is made of a ferromagnetic material such as iron capable of forming a path through which magnetism may flow. The fourth pole piece 360 includes a seventh interaction surface 362, an eighth interaction surface 364, a seventh support surface 366, and an eighth support surface 368.

The seventh interaction surface 362 is provided at one outer end of the fourth pole piece 360. When a magnetic flow is formed on the seventh interaction surface 362, the holding object 1 having magnetism may be held on the seventh interaction surface 362. The seventh interaction surface 362 is disposed in parallel with the fifth interaction surface 352 in the vertical direction so as to be stably in contact with the holding object 1.

When the magnetic flow is formed on the fifth interaction surface 352 and the seventh interaction surface 362, the holding object 1 may come into contact with the fifth interaction surface 352 and the seventh interaction surface 362. When the holding object 1 is in contact with the fifth interaction surface 352 and the seventh interaction surface 362, the holding object 1 forms the magnetic flow together with the third pole piece 350 and the fourth pole piece 360 and is held on the magnetic body holding device 300.

The eighth interaction surface 364 is provided at the other outer end of the fourth pole piece 360. When a magnetic flow is formed on the eighth interaction surface 364, the holding object 2 having magnetism may be held on the eighth interaction surface 364. That is, the eighth interaction surface 364 and the seventh interaction surface 362 are provided to hold different holding objects. The eighth interaction surface 364 is disposed in parallel with the sixth interaction surface 354 in the vertical direction so as to be stably in contact with the holding object 2.

When the magnetic flow is formed on the sixth interaction surface 354 and the eighth interaction surface 364, the holding object 2 may come into contact with the sixth interaction surface 354 and the eighth interaction surface 364. When the holding object 2 is in contact with the sixth interaction surface 354 and the eighth interaction surface 364, the holding object 2 forms the magnetic flow together with the third pole piece 350 and the fourth pole piece 360 and is held on the magnetic body holding device 300.

The seventh support surface 366 is provided on one portion of an inner surface of the fourth pole piece 360. The seventh support surface 366 is disposed to face the fifth support surface 356.

The seventh support surface 366 is in contact with the other end of the third stationary magnet 372 to support the third stationary magnet 372. FIGS. 5A to 5D illustrate the structure in which the seventh support surface 366 is in contact with the S-pole of the third stationary magnet 372, but a structure in which the seventh support surface 366 is in contact with the N-pole of the third stationary magnet 372 may also be applied.

The eighth support surface 368 is provided on the other portion of the inner surface of the fourth pole piece 360. The eighth support surface 368 is disposed to face the sixth support surface 358.

The eighth support surface 368 is in contact with the other end of the fourth stationary magnet 374 to support the fourth stationary magnet 374. FIGS. 5A to 5D illustrate the structure in which the eighth support surface 368 is in contact with the S-pole of the fourth stationary magnet 374, but a structure in which the eighth support surface 368 is in contact with the N-pole of the fourth stationary magnet 374 may also be applied.

The third pole piece 350, together with the fourth pole piece 360, defines a second receiving portion 355 that receives the second rotary magnet 380. The second receiving portion 355 receives the second rotary magnet 380 and includes a rotation path Pa2 for the second rotary magnet 380.

The pair of stationary magnets 370 includes the third stationary magnet 372 and the fourth stationary magnet 374. The third stationary magnet 372 and the fourth stationary magnet 374 are permanent magnets.

The N-pole of the third stationary magnet 372 is disposed to be in contact with the third pole piece 350, and the S-pole of the third stationary magnet 372 is disposed to be in contact with the fourth pole piece 360. The third stationary magnet 372 may be disposed to be closer to the fifth interaction surface 352 and the seventh interaction surface 362 than the second rotary magnet 380 and the rotation center Ce2 of the second rotary magnet 380.

The N-pole of the fourth stationary magnet 374 is disposed to be in contact with the third pole piece 350, and the S-pole of the fourth stationary magnet 374 is disposed to be in contact with the fourth pole piece 360. The fourth stationary magnet 374 may be disposed to be closer to the sixth interaction surface 354 and the eighth interaction surface 364 than the second rotary magnet 380 and the rotation center Ce2 of the second rotary magnet 380.

The second rotary magnet 380 includes a second permanent magnet 384 and a second rotary shaft 382 disposed rotatably. The second permanent magnet 384 is disposed to be rotatable about the second rotary shaft 382.

The second rotary magnet 380 is disposed to be rotatable between the first position (see FIG. 5A) at which the S-pole of the second rotary magnet 380 is adjacent to the third pole piece 350 and magnetically connected to the third pole piece 350 and the N-pole of the second rotary magnet 380 is adjacent to the fourth pole piece 360 and magnetically connected to the fourth pole piece 360 and the second position (see FIG. 5C) at which the N-pole of the second rotary magnet 380 is adjacent to the third pole piece 350 and magnetically connected to the third pole piece 350 and the S-pole of the second rotary magnet 380 is adjacent to the fourth pole piece 360 and magnetically connected to the fourth pole piece 360.

The configuration in which the second rotary magnet 380 is “magnetically connected” to the third pole piece 350 or the fourth pole piece 360 includes a case in which the second rotary magnet 380 is spaced apart from the third pole piece 350 or the fourth pole piece 360 to the extent that the magnetic flow may be formed on the third pole piece 350 or the fourth pole piece 360 by the second rotary magnet 380 even though the second rotary magnet 380 is not physically in direct contact with the third pole piece 350 or the fourth pole piece 360.

For example, it can be said that the second rotary magnet 380 is magnetically connected to the third pole piece 350 or the fourth pole piece 360 when the magnetic flow having intensity, which is equal to or higher than A % of intensity of the magnetic flow generated when the second rotary magnet 380 comes into contact with the third pole piece 350 or the fourth pole piece 360, is formed on the third pole piece 350 or the fourth pole piece 360. In this case, A may be 80, 70, 60, 50, 40, 30, 20, or the like.

The second rotary magnet 380 is disposed to be spaced apart from the pair of stationary magnets 370 in the horizontal direction.

The pair of coils 304 may be wound around the second pole piece 320 of the first magnetic body holding module 301 and the third pole piece 350 of the second magnetic body holding module 302.

The pair of coils 304 is shared by the first magnetic body holding module 301 and the second magnetic body holding module 302, and it is possible to simultaneously control the magnetic force or the magnetic flow of the first magnetic body holding module 301 and the second magnetic body holding module 302 by controlling the current to be applied to the pair of coils 304.

The pair of coils 304 includes a first coil 304a and a second coil 304b. As illustrated in FIGS. 5A to 5D, the first coil 304a is disposed between the first stationary magnet 332 and the first rotary magnet 340 and between the third stationary magnet 372 and the second rotary magnet 380, and the second coil 304b is disposed between the second stationary magnet 334 and the first rotary magnet 340 and between the fourth stationary magnet 374 and the second rotary magnet 380. The first coil 304a and the second coil 304b are disposed at both sides of the first rotary magnet 340 and the second rotary magnet 380, respectively, with the first rotary magnet 340 and the second rotary magnet 380 interposed therebetween.

When the current flows through the first coil 304a and the second coil 304b, the magnetic flow is formed in a predetermined direction by Ampere's right-handed screw rule, and the N-poles and the S-poles are formed in the direction of the magnetic flow on the second pole piece 320 and the third pole piece 350 around which the first coil 304a and the second coil 304b are wound. That is, it can be seen that the first coil 304a, the second coil 304b, and one portion of the second pole piece 320 and the third pole piece 350 around which the first coil 304a and the second coil 304b are wound serve as an electromagnet.

The diamagnetic body 303 is disposed between the second pole piece 320 and the third pole piece 350.

The diamagnetic body 303 has repulsive force against the magnetic field formed outside, and does not form the magnetic flow, or blocks the magnetic flow. Therefore, the diamagnetic body 303 prevents magnetic interference between the first magnetic body holding module 301 and the second magnetic body holding module 302.

Hereinafter, a principle of holding the holding objects 1 and 2, which are the magnetic bodies, or releasing the holding objects 1 and 2 will be described with reference back to FIGS. 5A to 5D.

First, referring to FIG. 5A, when no power is applied to the first coil 304a and the second coil 304b and thus no current flows, a portion of the first pole piece 310 being in contact with the S-pole of the first stationary magnet 332, that is, the portion of the first pole piece 310, which is adjacent to the S-pole of the first stationary magnet 332, is magnetized as the N-pole, and a portion of the first pole piece 310, which is relatively distant from the S-pole of the first stationary magnet 332, that is, the portion of the first pole piece 310, which is adjacent to the first rotary magnet 340, is magnetized as the S-pole.

A portion of the second pole piece 320 being in contact with the N-pole of the first stationary magnet 332, that is, the portion of the second pole piece 320, which is adjacent to the N-pole of the first stationary magnet 332, is magnetized as the S-pole, and a portion of the second pole piece 320, which is relatively distant from the N-pole of the first stationary magnet 132, that is, the portion of the second pole piece 320, which is adjacent to the first rotary magnet 340, is magnetized as the N-pole.

Likewise, a portion of the first pole piece 110 being in contact with the S-pole of the second stationary magnet 334, that is, the portion of the first pole piece 110, which is adjacent to the S-pole of the second stationary magnet 334, is magnetized as the N-pole, and a portion of the first pole piece 110, which is relatively distant from the S-pole of the second stationary magnet 334, that is, the portion of the first pole piece 110, which is adjacent to the first rotary magnet 340, is magnetized as the S-pole.

A portion of the second pole piece 320 being in contact with the N-pole of the second stationary magnet 334, that is, the portion of the second pole piece 320, which is adjacent to the N-pole of the second stationary magnet 334, is magnetized as the S-pole, and a portion of the second pole piece 320, which is relatively distant from the N-pole of the second stationary magnet 334, that is, the portion of the second pole piece 320, which is adjacent to the first rotary magnet 340, is magnetized as the N-pole.

Therefore, the first rotary magnet 340 is rotated and disposed at the first position at which the N-pole of the first rotary magnet 340 is adjacent to the first pole piece 310 and magnetically connected to the first pole piece 310 and the S-pole of the first rotary magnet 340 is adjacent to the second pole piece 320 and magnetically connected to the second pole piece 320.

When the first rotary magnet 340 is rotated and disposed at the first position, one magnetic closed loop CLD1 is formed along the first stationary magnet 332, the second pole piece 320, the first rotary magnet 340, and the first pole piece 310, as indicated by the dotted line illustrated in FIG. 5A. In addition, when the first rotary magnet 340 is rotated and disposed at the first position, the other magnetic closed loop CLD2 is formed along the second stationary magnet 334, the second pole piece 320, the first rotary magnet 340, and the first pole piece 310.

Based on the similar principle, when the second rotary magnet 380 is rotated and disposed at the first position, one magnetic closed loop CLD3 is formed along the third stationary magnet 372, the third pole piece 350, the second rotary magnet 380, and the fourth pole piece 380, as indicated by the dotted line illustrated in FIG. 5A. In addition, when the second rotary magnet 380 is rotated and disposed at the first position, the other magnetic closed loop CLD4 is formed along the fourth stationary magnet 374, the third pole piece 350, the second rotary magnet 380, and the fourth pole piece 380.

In the state in which the first rotary magnet 340 and the second rotary magnet 380 are rotated and disposed at the first position, no magnetic flow is formed in the direction toward the first to eighth interaction surfaces 312, 314, 322, 324, 352, 354, 362, and 364, and as a result, the holding objects 1 and 2 cannot be held on the first to eighth interaction surfaces 312, 314, 322, 324, 352, 354, 362, and 364. That is, the holding objects 1 and 2 cannot be held on the first magnetic body holding module 301 and the second magnetic body holding module 302.

When the first coil 304a and the second coil 304b are controlled so that the current flows through the first coil 304a and the second coil 304b as illustrated in FIG. 5B, and thus when a sufficient current flows through the first coil 304a and the second coil 304b, the first rotary magnet 340 receives repulsive force from the second pole piece 320, and the second rotary magnet 380 receives repulsive force from the third pole piece 350, such that the first rotary magnet 340 and the second rotary magnet 380 are rotated.

When the first rotary magnet 340 and the second rotary magnet 380 are rotated by 180 degrees from the first position and disposed at the second position as illustrated in FIG. 5C, the S-pole of the first rotary magnet 340 is adjacent to the first pole piece 310 and magnetically connected to the first pole piece 310, and the N-pole of the first rotary magnet 340 is adjacent to the second pole piece 320 and magnetically capture the second pole piece 320. In addition, the N-pole of the second rotary magnet 380 is adjacent to the third pole piece 350 and magnetically connected to the third pole piece 350, and the S-pole of the second rotary magnet 380 is adjacent to the fourth pole piece 360 and magnetically connected to the fourth pole piece 360.

When the first rotary magnet 340 and the second rotary magnet 380 are rotated and disposed at the second position, the magnetic flow is formed on the first to eighth interaction surfaces 312, 314, 322, 324, 352, 354, 362, and 364, that is, all the interaction surfaces, and the magnetic flow may form the magnetic closed loop together with another magnetic body. That is, the magnetic flow diverges through the first to eighth interaction surfaces 312, 314, 322, 324, 352, 354, 362, and 364. In this case, the “divergence of the magnetic flow” includes both a case in which the magnetic flow is formed to the outside from the first to eighth interaction surfaces 312, 314, 322, 324, 352, 354, 362, and 364 and a case in which the magnetic flow is formed from the outside to the first to eighth interaction surfaces 312, 314, 322, 324, 352, 354, 362, and 364.

Therefore, when the holding object 1 having magnetism comes into contact with the first interaction surface 312, the third interaction surface 322, the fifth interaction surface 352, and the seventh interaction surface 362, the holding object 1 forms a magnetic closed loop together with the first rotary magnet 340, the first pole piece 310, and the second pole piece 320, and forms another magnetic closed loop together with the second rotary magnet 380, the third pole piece 350, and the fourth pole piece 360, such that the holding object 1 is held on the first interaction surface 312, the third interaction surface 322, the fifth interaction surface 352, and the seventh interaction surface 362 at one side of the magnetic body holding device 300.

In addition, when the holding object 2 having magnetism comes into contact with the second interaction surface 314, the fourth interaction surface 324, the sixth interaction surface 354, and the eighth interaction surface 364, the holding object 2 forms a magnetic closed loop together with the first rotary magnet 340, the first pole piece 310, and the second pole piece 320, and forms another magnetic closed loop together with the second rotary magnet 380, the third pole piece 350, and the fourth pole piece 360, such that the holding object 2 is held on the second interaction surface 314, the fourth interaction surface 324, the sixth interaction surface 354, and the eighth interaction surface 364 at the other side of the magnetic body holding device 300.

In the state in which the first rotary magnet 340 and the second rotary magnet 380 are disposed at the second position, the first stationary magnet 332, the second stationary magnet 334, the third stationary magnet 372, and the fourth stationary magnet 374 cannot form the magnetic flow together with the first rotary magnet 340 or the second rotary magnet 380, and as a result, the first stationary magnet 332, the second stationary magnet 334, the third stationary magnet 372, and the fourth stationary magnet 374 form other magnetic closed loops together with the holding objects 1 and 2.

As described above, since the holding objects 1 and 2 form different magnetic closed loops together with the first rotary magnet 340, the second rotary magnet 380, the first stationary magnet 332, the second stationary magnet 334, the third stationary magnet 372, and the fourth stationary magnet 374, the holding objects 1 and 2 may be stably held by the magnetic body holding device 300.

When the magnetic closed loops are formed as illustrated in FIG. 5C, the magnetic closed loops are maintained even though the voltage applied to the first coil 304a and the second coil 304b is eliminated, and as a result, the holding objects 1 and 2 remain held.

When the first coil 304a and the second coil 304b are controlled, as illustrated in FIG. 5D, in the state in which the first rotary magnet 340 and the second rotary magnet 380 are disposed at the second position so that the current flows in the direction opposite to the direction of the flow of the current illustrated in FIG. 3B, the first rotary magnet 340 and the second rotary magnet 380 are rotated back to the first position, as illustrated in FIG. 5A, such that the first rotary magnet 340 forms magnetic closed loops CLD1 and CLD2 together with the first stationary magnet 332 and the second stationary magnet 334, the second rotary magnet 380 forms other magnetic closed loops CLD3 and CLD4 together with the third stationary magnet 372 and the fourth stationary magnet 374, and as a result, the holding objects 1 and 2 may be separated from the magnetic body holding device 300.

In the exemplary embodiment illustrated in FIGS. 5A to 5D, there has been described the example in which the first coil 304a and the second coil 304b are controlled so that the current flows through both the first coil 304a and the second coil 304b or no current flows through the first coil 304a and the second coil 304b. However, the first coil 304a and the second coil 304b may be controlled so that the current flows through the first coil 304a, and no current flows through the second coil 304b, or the first coil 304a and the second coil 304b may be controlled so that no current flows through the first coil 304a, and the current flows through the second coil 304b.

Hereinafter, a magnetic body holding device 500 according to still another further exemplary embodiment of the present disclosure will be described. A description of parts identical to the above-mentioned parts of the magnetic body holding device 300 according to another exemplary embodiment of the present disclosure will be omitted, and only parts different from the above-mentioned parts of the magnetic body holding device 100 will be described.

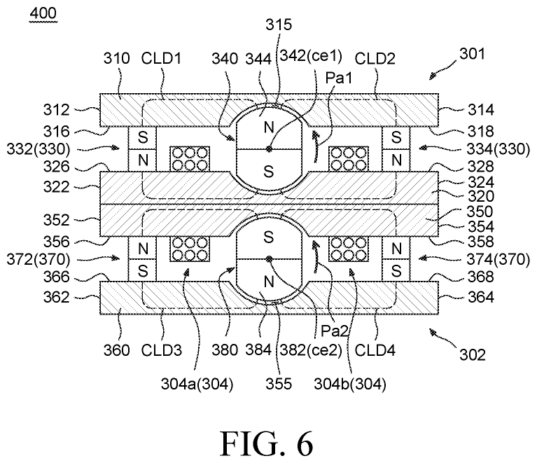

FIG. 6 is a view schematically illustrating the magnetic body holding device according to still another further exemplary embodiment of the present disclosure;

Referring to FIG. 6, a magnetic body holding device 400 has a structure in which the diamagnetic body 303 is omitted from the above-mentioned magnetic body holding device 300.

Therefore, the magnetic body holding device 400 has a structure in which the second pole piece 320 and the third pole piece 350 are coupled to each other.

FIG. 6 illustrates the structure of the magnetic body holding device 400 in which the second pole piece 320 and the third pole piece 350 are coupled to each other, but the second pole piece 320 and the third pole piece 350 may be integrally formed.

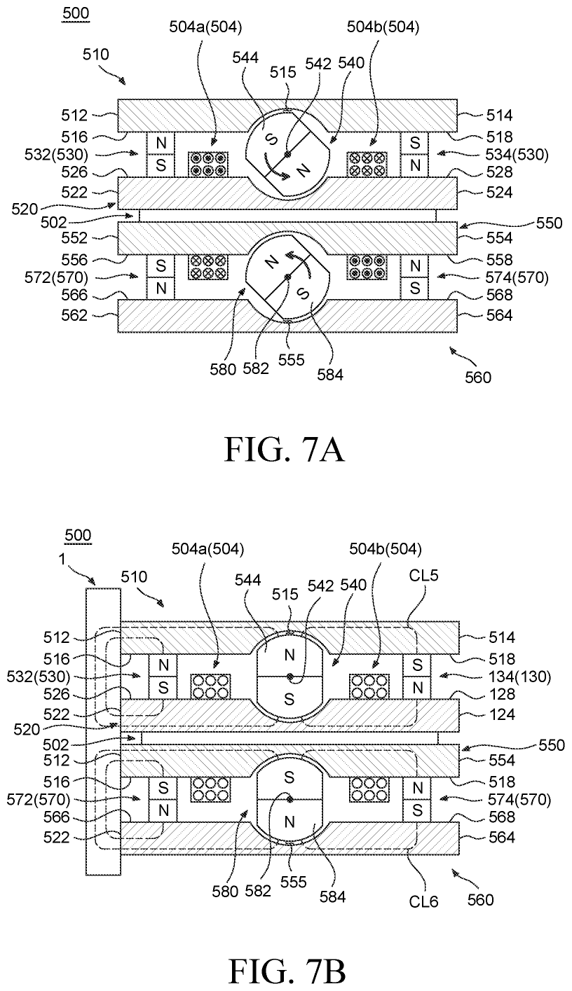

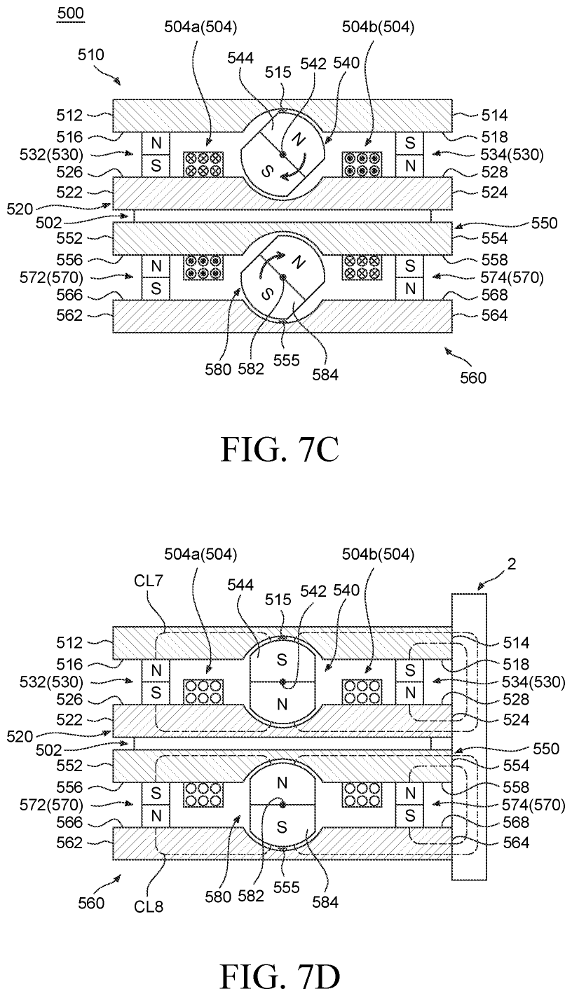

FIGS. 7A to 7D are views schematically illustrating a magnetic body holding device according to another further exemplary embodiment of the present disclosure.

Referring to FIGS. 7A to 7D, the magnetic body holding device 500 includes a first magnetic body holding module 501, a second magnetic body holding module 502, a diamagnetic body 503 disposed between the first magnetic body holding module 501 and the second magnetic body holding module 502, and a pair of coils 504 shared by the first magnetic body holding module 501 and the second magnetic body holding module 502.

The first magnetic body holding module 501 includes a first pole piece 510, a second pole piece 520, a pair of stationary magnets 530, and a first rotary magnet 540.

The first pole piece 510 is made of a ferromagnetic material such as iron capable of forming a path through which magnetism may flow. The first pole piece 510 includes a first interaction surface 512, a second interaction surface 514, a first support surface 516, and a second support surface 518.

The first interaction surface 512 is provided at one outer end of the first pole piece 510. When a magnetic flow is formed on the first interaction surface 512, the holding object 1 having magnetism may be held on the first interaction surface 512.

The second interaction surface 514 is provided at the other outer end of the first pole piece 510. When a magnetic flow is formed on the second interaction surface 514, the holding object 2 having magnetism may be held on the second interaction surface 514. That is, the second interaction surface 514 and the first interaction surface 512 are provided to hold different holding objects.

The first support surface 516 is provided on one portion of an inner surface of the first pole piece 510. The first support surface 516 is in contact with one end of a first stationary magnet 532 to support the first stationary magnet 532. FIGS. 7A to 7D illustrate the structure in which the first support surface 516 is in contact with the N-pole of the first stationary magnet 532, but a structure in which the first support surface 516 is in contact with the S-pole of the first stationary magnet 532 may also be applied.

The second support surface 518 is provided on the other portion of the inner surface of the first pole piece 510. The second support surface 518 is in contact with one end of a second stationary magnet 534 to support the second stationary magnet 534. FIGS. 7A to 7D illustrate the structure in which the second support surface 518 is in contact with the S-pole of the second stationary magnet 534, but a structure in which the second support surface 518 is in contact with the N-pole of the second stationary magnet 534 may also be applied.

The second pole piece 520 is disposed to be spaced apart from the first pole piece 510 in the vertical direction with the pair of stationary magnets 530 interposed therebetween.

The second pole piece 520 is made of a ferromagnetic material such as iron capable of forming a path through which magnetism may flow. The second pole piece 520 includes a third interaction surface 522, a fourth interaction surface 524, a third support surface 526, and a fourth support surface 528.

The third interaction surface 522 is provided at one outer end of the second pole piece 520. When a magnetic flow is formed on the third interaction surface 522, the holding object 1 having magnetism may be held on the third interaction surface 522. The third interaction surface 522 is disposed in parallel with the first interaction surface 512 in the vertical direction so as to be stably in contact with the holding object 1.

When the magnetic flow is formed on the first interaction surface 512 and the third interaction surface 522, the holding object 1 may come into contact with the first interaction surface 512 and the third interaction surface 522. When the holding object 1 is in contact with the first interaction surface 512 and the third interaction surface 522, the holding object 1 forms the magnetic flow together with the first pole piece 510 and the second pole piece 520 and is held on the magnetic body holding device 500.

The fourth interaction surface 524 is provided at the other outer end of the second pole piece 520. When a magnetic flow is formed on the fourth interaction surface 524, the holding object 2 having magnetism may be held on the fourth interaction surface 524. That is, the fourth interaction surface 524 and the third interaction surface 522 are provided to hold different holding objects. The fourth interaction surface 524 is disposed in parallel with the second interaction surface 514 in the vertical direction so as to be stably in contact with the holding object 2.

When the magnetic flow is formed on the second interaction surface 514 and the fourth interaction surface 524, the holding object 2 may come into contact with the second interaction surface 514 and the fourth interaction surface 524. When the holding object 2 is in contact with the second interaction surface 514 and the fourth interaction surface 524, the holding object 2 forms the magnetic flow together with the first pole piece 510 and the second pole piece 520 and is held on the magnetic body holding device 500.

The third support surface 526 is provided at one portion of an inner surface of the second pole piece 520. The third support surface 526 is disposed to face the first support surface 516.

The third support surface 526 is in contact with the other end of the first stationary magnet 532 to support the first stationary magnet 532. FIGS. 7A to 7D illustrate the structure in which the third support surface 526 is in contact with the S-pole of the first stationary magnet 532, but a structure in which the third support surface 526 is in contact with the N-pole of the first stationary magnet 532 may also be applied.

The fourth support surface 528 is provided on the other portion of the inner surface of the second pole piece 520. The fourth support surface 528 is disposed to face the second support surface 518.

The fourth support surface 528 is in contact with the other end of the second stationary magnet 534 to support the second stationary magnet 534. FIGS. 7A to 7D illustrate the structure in which the fourth support surface 528 is in contact with the N-pole of the second stationary magnet 534, but a structure in which the fourth support surface 528 is in contact with the S-pole of the second stationary magnet 534 may also be applied.

The second pole piece 520, together with the first pole piece 510, defines a first receiving portion 515 that receives the first rotary magnet 540. The first receiving portion 515 receives the first rotary magnet 540.

The pair of stationary magnets 530 includes the first stationary magnet 532 and the second stationary magnet 534. The first stationary magnet 532 and the second stationary magnet 534 are permanent magnets.

The N-pole of the first stationary magnet 532 is disposed to be in contact with the first pole piece 510, and the S-pole of the first stationary magnet 532 is disposed to be in contact with the second pole piece 520. The first stationary magnet 532 may be disposed to be closer to the first interaction surface 512 and the third interaction surface 522 than the first rotary magnet 540.

The S-pole of the second stationary magnet 534 is disposed to be in contact with the first pole piece 510, and the N-pole of the second stationary magnet 534 is disposed to be in contact with the second pole piece 520. The second stationary magnet 534 may be disposed to be closer to the second interaction surface 514 and the fourth interaction surface 524 than the first rotary magnet 540.

The first rotary magnet 540 includes a first permanent magnet 544 and a first rotary shaft 542 disposed rotatably. The first permanent magnet 544 is disposed to be rotatable about the first rotary shaft 542.

The first rotary magnet 540 is disposed to be rotatable between a first position (see FIG. 5B) at which the N-pole of the first rotary magnet 540 is adjacent to the first pole piece 510 and magnetically connected to the first pole piece 510 and the S-pole of the first rotary magnet 540 is adjacent to the second pole piece 520 and magnetically connected to the second pole piece 520 and a second position (see FIG. 5D) at which the S-pole of the first rotary magnet 540 is adjacent to the first pole piece 510 and magnetically connected to the first pole piece 510 and the N-pole of the first rotary magnet 540 is adjacent to the second pole piece 520 and magnetically connected to the second pole piece 520.

The configuration in which the first rotary magnet 540 is “magnetically connected” to the first pole piece 510 or the second pole piece 520 includes a case in which the first rotary magnet 540 is spaced apart from the first pole piece 510 or the second pole piece 520 to the extent that the magnetic flow may be formed on the first pole piece 510 or the second pole piece 520 by the first rotary magnet 540 even though the first rotary magnet 540 is not physically in direct contact with the first pole piece 510 or the second pole piece 520.

For example, it can be said that the first rotary magnet 540 is magnetically connected to the first pole piece 510 or the second pole piece 520 when the magnetic flow having intensity, which is equal to or higher than A % of intensity of the magnetic flow generated when the first rotary magnet 540 comes into contact with the first pole piece 510 or the second pole piece 520, is formed on the first pole piece 510 or the second pole piece 520. In this case, A may be 80, 70, 60, 50, 40, 30, 20, or the like.

The first rotary magnet 540 is disposed to be spaced apart from the pair of stationary magnets 530 in the horizontal direction.

The second magnetic body holding module 502 is disposed to be spaced apart from the first magnetic body holding module 501 in the vertical direction. The diamagnetic body 503 is disposed between the first magnetic body holding module 501 and the second magnetic body holding module 502 to prevent magnetic interference that may occur between the first magnetic body holding module 501 and the second magnetic body holding module 502.

The second magnetic body holding module 502 and the first magnetic body holding module 501 are symmetrically disposed with respect to the diamagnetic body 503.

The second magnetic body holding module 502 includes a third pole piece 550, a fourth pole piece 560, a pair of stationary magnets 570, and a second rotary magnet 580.

The third pole piece 550 is made of a ferromagnetic material such as iron capable of forming a path through which magnetism may flow. The third pole piece 550 includes a fifth interaction surface 552, a sixth interaction surface 554, a fifth support surface 556, a sixth support surface 558.

The fifth interaction surface 552 is provided at one outer end of the third pole piece 550. When a magnetic flow is formed on the fifth interaction surface 552, the holding object 1 having magnetism may be held on the fifth interaction surface 552.

The sixth interaction surface 554 is provided at the other outer end of the third pole piece 550. When a magnetic flow formed on the sixth interaction surface 554, the holding object 2 having magnetism may be held on the sixth interaction surface 554. That is, the sixth interaction surface 554 and the fifth interaction surface 552 are provided to hold different holding objects.

The fifth support surface 556 is provided on one portion of an inner surface of the third pole piece 550. The fifth support surface 556 is in contact with one end of a third stationary magnet 572 to support the third stationary magnet 572. FIGS. 7A to 7D illustrate the structure in which the fifth support surface 556 is in contact with the S-pole of the third stationary magnet 572, but a structure in which the fifth support surface 556 is in contact with the N-pole of the third stationary magnet 572 may also be applied.

The sixth support surface 558 is provided on the other portion of the inner surface of the third pole piece 550. The sixth support surface 558 is in contact with one end of a fourth stationary magnet 574 to support the fourth stationary magnet 574. FIGS. 7A to 7D illustrate the structure in which the sixth support surface 558 is in contact with the N-pole of the fourth stationary magnet 574, but a structure in which the sixth support surface 558 is in contact with the S-pole of the fourth stationary magnet 574 may also be applied.

The fourth pole piece 560 is disposed to be spaced apart from the third pole piece 550 in the vertical direction with the pair of stationary magnets 570 interposed therebetween.

The fourth pole piece 560 is made of a ferromagnetic material such as iron capable of forming a path through which magnetism may flow. The fourth pole piece 560 includes a seventh interaction surface 562, an eighth interaction surface 564, a seventh support surface 566, and an eighth support surface 568.

The seventh interaction surface 562 is provided at one outer end of the fourth pole piece 560. When a magnetic flow is formed on the seventh interaction surface 562, the holding object 1 having magnetism may be held on the seventh interaction surface 562. The seventh interaction surface 562 is disposed in parallel with the fifth interaction surface 552 in the vertical direction so as to be stably in contact with the holding object 1.

When the magnetic flow is formed on the fifth interaction surface 552 and the seventh interaction surface 562, the holding object 1 may come into contact with the fifth interaction surface 552 and the seventh interaction surface 562. When the holding object 1 is in contact with the fifth interaction surface 552 and the seventh interaction surface 562, the holding object 1 forms the magnetic flow together with the third pole piece 550 and the fourth pole piece 560 and is held on the magnetic body holding device 500.

The eighth interaction surface 564 is provided at the other outer end of the fourth pole piece 560. When a magnetic flow is formed on the eighth interaction surface 564, the holding object 2 having magnetism may be held on the eighth interaction surface 564. That is, the eighth interaction surface 564 and the seventh interaction surface 562 are provided to hold different holding objects. The eighth interaction surface 564 is disposed in parallel with the sixth interaction surface 554 in the vertical direction so as to be stably in contact with the holding object 2.

When the magnetic flow is formed on the sixth interaction surface 554 and the eighth interaction surface 564, the holding object 2 may come into contact with the sixth interaction surface 554 and the eighth interaction surface 564. When the holding object 2 is in contact with the sixth interaction surface 554 and the eighth interaction surface 564, the holding object 2 forms the magnetic flow together with the third pole piece 550 and the fourth pole piece 560 and is held on the magnetic body holding device 500.

The seventh support surface 566 is provided on one portion of an inner surface of the fourth pole piece 560. The seventh support surface 566 is disposed to face the fifth support surface 556.

The seventh support surface 566 is in contact with the other end of the third stationary magnet 572 to support the third stationary magnet 572. FIGS. 7A to 7D illustrate the structure in which the seventh support surface 566 is in contact with the S-pole of the third stationary magnet 572, but a structure in which the seventh support surface 566 is in contact with the N-pole of the third stationary magnet 572 may also be applied.

The eighth support surface 568 is provided on the other portion of the inner surface of the fourth pole piece 560. The eighth support surface 568 is disposed to face the sixth support surface 558.

The eighth support surface 568 is in contact with the other end of the fourth stationary magnet 574 to support the fourth stationary magnet 574. FIGS. 7A to 7D illustrate the structure in which the eighth support surface 568 is in contact with the S-pole of the fourth stationary magnet 574, but a structure in which the eighth support surface 568 is in contact with the N-pole of the fourth stationary magnet 574 may also be applied.

The third pole piece 550, together with the fourth pole piece 560, defines a second receiving portion 555 that receives the second rotary magnet 580. The second receiving portion 555 receives the second rotary magnet 580.

The pair of stationary magnets 570 includes the third stationary magnet 572 and the fourth stationary magnet 574. The third stationary magnet 572 and the fourth stationary magnet 574 are permanent magnets.

The S-pole of the third stationary magnet 572 is disposed to be in contact with the third pole piece 550, and the N-pole of the third stationary magnet 572 is disposed to be in contact with the fourth pole piece 560. The third stationary magnet 572 may be disposed to be closer to the fifth interaction surface 552 and the seventh interaction surface 562 than the second rotary magnet 580.

The N-pole of the fourth stationary magnet 574 is disposed to be in contact with the third pole piece 550, and the S-pole of the fourth stationary magnet 574 is disposed to be in contact with the fourth pole piece 560. The fourth stationary magnet 574 may be disposed to be closer to the sixth interaction surface 554 and the eighth interaction surface 564 than the second rotary magnet 580.

The second rotary magnet 580 includes a second permanent magnet 584 and a second rotary shaft 582 disposed rotatably. The second permanent magnet 584 is disposed to be rotatable about the second rotary shaft 582.

The second rotary magnet 580 is disposed to be rotatable between the first position (see FIG. 7B) at which the S-pole of the second rotary magnet 580 is adjacent to the third pole piece 550 and magnetically connected to the third pole piece 550 and the N-pole of the second rotary magnet 580 is adjacent to the fourth pole piece 560 and magnetically connected to the fourth pole piece 560 and the second position (see FIG. 7D) at which the N-pole of the second rotary magnet 580 is adjacent to the third pole piece 550 and magnetically connected to the third pole piece 550 and the S-pole of the second rotary magnet 580 is adjacent to the fourth pole piece 560 and magnetically connected to the fourth pole piece 560.

The configuration in which the second rotary magnet 580 is “magnetically connected” to the third pole piece 550 or the fourth pole piece 560 includes a case in which the second rotary magnet 580 is spaced apart from the third pole piece 550 or the fourth pole piece 560 to the extent that the magnetic flow may be formed on the third pole piece 550 or the fourth pole piece 560 by the second rotary magnet 580 even though the second rotary magnet 580 is not physically in direct contact with the third pole piece 550 or the fourth pole piece 560.

For example, it can be said that the second rotary magnet 580 is magnetically connected to the third pole piece 550 or the fourth pole piece 560 when the magnetic flow having intensity, which is equal to or higher than A % of intensity of the magnetic flow generated when the second rotary magnet 580 comes into contact with the third pole piece 550 or the fourth pole piece 560, is formed on the third pole piece 550 or the fourth pole piece 560. In this case, A may be 80, 70, 60, 50, 40, 30, 20, or the like.

The second rotary magnet 580 is disposed to be spaced apart from the pair of stationary magnets 570 in the horizontal direction.

The pair of coils 504 may be wound around the second pole piece 520 of the first magnetic body holding module 501 and the third pole piece 550 of the second magnetic body holding module 502.

The pair of coils 504 is shared by the first magnetic body holding module 501 and the second magnetic body holding module 502, and it is possible to simultaneously control the magnetic force or the magnetic flow of the first magnetic body holding module 501 and the second magnetic body holding module 502 by controlling the current to be applied to the pair of coils 504.

The pair of coils 504 includes a first coil 504a and a second coil 504b. As illustrated in FIGS. 7A to 7D, the first coil 504a is disposed between the first stationary magnet 532 and the first rotary magnet 540 and between the third stationary magnet 572 and the second rotary magnet 580, and the second coil 504b is disposed between the second stationary magnet 534 and the first rotary magnet 540 and between the fourth stationary magnet 574 and the second rotary magnet 580. The first coil 504a and the second coil 504b are disposed at both sides of the first rotary magnet 540 and the second rotary magnet 580, respectively, with the first rotary magnet 540 and the second rotary magnet 580 interposed therebetween.

When the current flows through the first coil 504a and the second coil 504b, the magnetic flow is formed in a predetermined direction by Ampere's right-handed screw rule, and the N-poles and the S-poles are formed in the direction of the magnetic flow on the second pole piece 520 and the third pole piece 550 around which the first coil 504a and the second coil 504b are wound. That is, it can be seen that the first coil 504a, the second coil 504b, and one portion of the second pole piece 520 and the third pole piece 550 around which the first coil 504a and the second coil 504b are wound serve as an electromagnet.

The diamagnetic body 503 is disposed between the second pole piece 520 and the third pole piece 550.

The diamagnetic body 503 has repulsive force against the magnetic field formed outside, and does not form the magnetic flow, or blocks the magnetic flow. Therefore, the diamagnetic body 503 prevents magnetic interference between the first magnetic body holding module 501 and the second magnetic body holding module 502.

Hereinafter, a principle of holding or releasing the holding objects 1 and 2, which are the magnetic bodies, will be described with reference to FIGS. 7A to 7D.

As illustrated in FIG. 7A, when a sufficient current flows through the first coil 504a and the second coil 504b, the first rotary magnet 540 receives repulsive force from the first pole piece 510, and the first rotary magnet 540 is rotated.

In addition, as illustrated in FIG. 7A, when a sufficient current flows through the first coil 504a and the second coil 504b, the second rotary magnet 580 receives repulsive force from the fourth pole piece 540, and the second rotary magnet 580 is rotated.

When the first rotary magnet 540 is rotated and disposed at the first position as illustrated in FIG. 7B, the N-pole of the first rotary magnet 540 is adjacent to the first pole piece 510 and magnetically connected to the first pole piece 510, and the S-pole of the first rotary magnet 540 is adjacent to the second pole piece 520 and magnetically connected to the second pole piece 520.

In addition, when the second rotary magnet 580 is rotated and disposed at the first position as illustrated in FIG. 7B, the S-pole of the second rotary magnet 580 is adjacent to the third pole piece 530 and magnetically connected to the third pole piece 510, and the N-pole of the second rotary magnet 580 is adjacent to the fourth pole piece 540 and magnetically connected to the fourth pole piece 540.

When the first rotary magnet 540 is disposed at the first position, the magnetic flow is formed on the first interaction surface 512 and the third interaction surface 522 by the first stationary magnet 532, and the magnetic flow may form the magnetic closed loop together with another magnetic body. That is, the magnetic flow diverges through the first interaction surface 512 and the third interaction surface 522.

In addition, when the second rotary magnet 580 is disposed at the first position, the magnetic flow is formed on the fifth interaction surface 552 and the seventh interaction surface 562 by the third stationary magnet 572, and the magnetic flow may form the magnetic closed loop together with another magnetic body. That is, the magnetic flow diverges through the fifth interaction surface 552 and the seventh interaction surface 562.

Therefore, when the holding object 1 having magnetism comes into contact with the first interaction surface 512, the third interaction surface 522, the fifth interaction surface 552, and the seventh interaction surface 562, the holding object 1 forms the magnetic closed loop, as illustrated in FIG. 7B, together with the first stationary magnet 532 and the third stationary magnet 572, such that the holding object 1 is held on the first interaction surface 512, the third interaction surface 522, the fifth interaction surface 552, and the seventh interaction surface 562 at one side of the magnetic body holding device 500.

When the magnetic closed loops are formed as illustrated in FIG. 7B, the magnetic closed loops are maintained even though the voltage applied to the first coil 504a and the second coil 504b is eliminated, and as a result, the holding object 1 remains held.

In addition, in the state in which the first rotary magnet 540 is disposed at the first position, one magnetic closed loop CL5 is formed along the second stationary magnet 534, the second pole piece 520, the first rotary magnet 540, and the first pole piece 510.

In addition, in the state in which the second rotary magnet 580 is disposed at the first position, one magnetic closed loop CL6 is formed along the fourth stationary magnet 574, the third pole piece 530, the second rotary magnet 580, and the fourth pole piece 540.

Therefore, no magnetic flow is formed in the direction toward the second interaction surface 514, the fourth interaction surface 524, the sixth interaction surface 554, and the eighth interaction surface 564, and as a result, the holding object 2 cannot be held on the second interaction surface 514, the fourth interaction surface 524, the sixth interaction surface 554, and the eighth interaction surface 564.

As illustrated in FIG. 7C, when a sufficient current flows through the first coil 504a and the second coil 504b in the direction opposite to the direction illustrated in FIG. 7A in the state in which the first rotary magnet 540 is disposed at the first position, the first rotary magnet 540 receives the repulsive force again from the first pole piece 510, and the first rotary magnet 540 is rotated.

In addition, as illustrated in FIG. 7C, when a sufficient current flows through the first coil 504a and the second coil 504b in the direction opposite to the direction illustrated in FIG. 7A in the state in which the second rotary magnet 580 is disposed at the first position, the second rotary magnet 580 receives the repulsive force again from the fourth pole piece 540, and the first rotary magnet 540 is rotated.

When the first rotary magnet 540 is rotated by 180 degrees from the first position and positioned at the second position as illustrated in FIG. 7D, the N-pole of the first rotary magnet 540 is adjacent to the second pole piece 520 and magnetically connected to the second pole piece 520, and the S-pole of the first rotary magnet 540 is adjacent to the first pole piece 510 and magnetically connected to the first pole piece 510.

In addition, when the second rotary magnet 580 is rotated by 180 degrees from the first position and disposed at the second position as illustrated in FIG. 7D, the N-pole of the second rotary magnet 580 is adjacent to the third pole piece 530 and magnetically connected to the third pole piece 530, and the S-pole of the second rotary magnet 580 is adjacent to the fourth pole piece 540 and magnetically connected to the fourth pole piece 540.

When the first rotary magnet 540 is disposed at the second position, the magnetic flow is formed on the second interaction surface 514 and the fourth interaction surface 524 by the second stationary magnet 534, and the magnetic flow may form the magnetic closed loop together with another magnetic body. That is, the magnetic flow diverges through the second interaction surface 514 and the fourth interaction surface 524.

In addition, when the second rotary magnet 580 is disposed at the second position, the magnetic flow is formed on the sixth interaction surface 554 and the eighth interaction surface 564 by the fourth stationary magnet 574, and the magnetic flow may form the magnetic closed loop together with another magnetic body. That is, the magnetic flow diverges through the sixth interaction surface 554 and the eighth interaction surface 564.

Therefore, when the holding object 2 having magnetism comes into contact with the second interaction surface 514, the fourth interaction surface 524, the sixth interaction surface 554, and the eighth interaction surface 564, the holding object 2 forms the magnetic closed loop, as illustrated in FIG. 7D, together with the second stationary magnet 534 and the fourth stationary magnet 574, such that the holding object 2 is held on the second interaction surface 514, the fourth interaction surface 524, the sixth interaction surface 554, and the eighth interaction surface 564 at one side of the magnetic body holding device 200.

When the magnetic closed loops are formed as illustrated in FIG. 7D, the magnetic closed loops are maintained even though the voltage applied to the first coil 504a and the second coil 504b is eliminated, and as a result, the holding object 2 remains held.

In the state in which the first rotary magnet 540 is disposed at the second position, one magnetic closed loop CL7 is formed along the first stationary magnet 532, the first pole piece 510, the first rotary magnet 540, and the second pole piece 520.

In addition, in the state in which the second rotary magnet 580 is disposed at the second position, one magnetic closed loop CL8 is formed along the second stationary magnet 534, the fourth pole piece 540, the second rotary magnet 580, and the third pole piece 520.

Therefore, no magnetic flow is formed in the direction toward the first interaction surface 512, the third interaction surface 522, the fifth interaction surface 552, and the seventh interaction surface 562, and as a result, the holding object 1 cannot be held on the first interaction surface 512, the third interaction surface 522, the fifth interaction surface 552, and the seventh interaction surface 562.

In the exemplary embodiment illustrated in FIGS. 7A to 7D, there has been described the example in which the first coil 504a and the second coil 504b are controlled so that the current flows through both the first coil 504a and the second coil 504b or no current flows through the first coil 504a and the second coil 504b. However, the first coil 504a and the second coil 504b may be controlled so that the current flows through the first coil 504a, and no current flows through the second coil 504b, or the first coil 504a and the second coil 504b may be controlled so that no current flows through the first coil 504a, and the current flows through the second coil 504b.

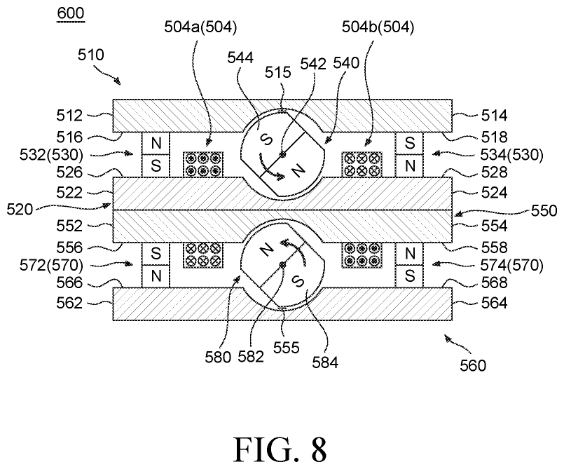

FIG. 8 is a view schematically illustrating the magnetic body holding device according to still another further exemplary embodiment of the present disclosure.

Referring to FIG. 8, a magnetic body holding device 600 has a structure in which the diamagnetic body 503 is omitted from the above-mentioned magnetic body holding device 500 according to another exemplary embodiment of the present disclosure.

Therefore, the magnetic body holding device 600 has a structure in which the second pole piece 520 and the third pole piece 550 are coupled to each other.

FIG. 8 illustrates the structure of the magnetic body holding device 600 in which the second pole piece 520 and the third pole piece 550 are coupled to each other, but the second pole piece 520 and the third pole piece 550 may be integrally formed.

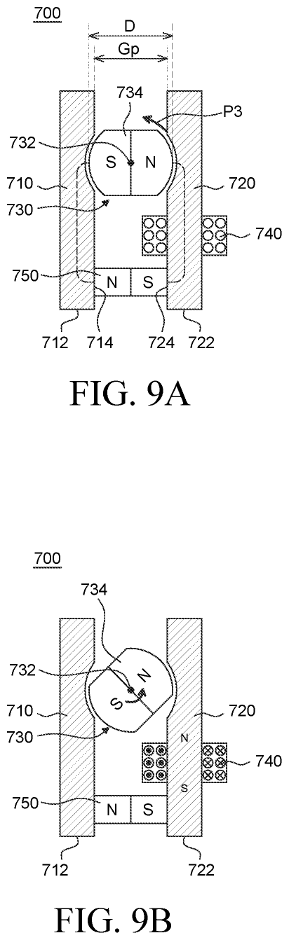

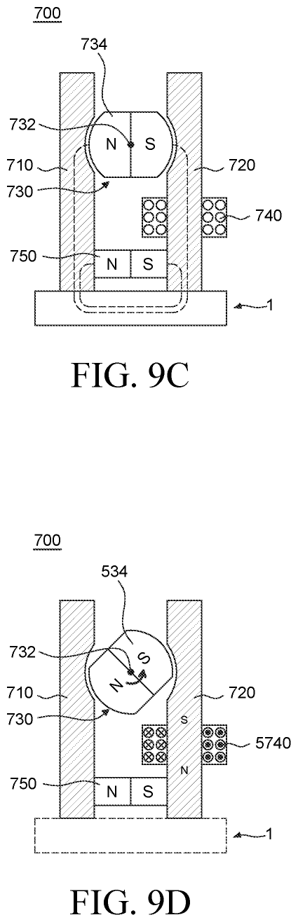

FIGS. 9A to 9D are views schematically illustrating a magnetic body holding device according to yet another further exemplary embodiment of the present disclosure.

Referring to FIGS. 9A to 9D, the magnetic body holding device 700 includes a first pole piece 710, a second pole piece 720, a rotary magnet 730, a coil 740, a stationary magnet 750.

The first pole piece 710 is made of a ferromagnetic material such as iron capable of forming a magnetic flow and includes a first interaction surface 712 and a first support surface 714.

The first interaction surface 712 is provided at one outer end of the first pole piece 710. When a magnetic flow is formed on the first interaction surface 712, the holding object 1 having magnetism may be held on the first interaction surface 712.

The first support surface 714 is provided on an inner surface of the first pole piece 710. The first support surface 714 is in contact with one end of the stationary magnet 750 to support the stationary magnet 750. FIGS. 9A to 9D illustrate the structure in which the first support surface 714 is in contact with the N-pole of the stationary magnet 750, but a structure in which the first support surface 714 is in contact with the S-pole of the stationary magnet 750 may also be applied.

The second pole piece 720 is disposed to be spaced apart from the first pole piece 710 with the stationary magnet 750 interposed therebetween.

The second pole piece 720 is made of a ferromagnetic material such as iron capable of forming a magnetic flow and includes a second interaction surface 722 and a second support surface 724.

The second interaction surface 722 is provided at one outer end of the second pole piece 720. When a magnetic flow is formed on the second interaction surface 722, the holding object 1 having magnetism may be held on the second interaction surface 722. The second interaction surface 722 is disposed in parallel with the first interaction surface 712 in the horizontal direction so as to be stably in contact with the holding object.

When the magnetic flow is formed on the first interaction surface 712 and the second interaction surface 722, the holding object may come into contact with the first interaction surface 712 and the second interaction surface 722. When the holding object is in contact with the first interaction surface 712 and the second interaction surface 722, the holding object forms the magnetic flow together with the first pole piece 710 and the second pole piece 720 and is held on the magnetic body holding device 700.

The second support surface 724 is provided on an inner surface of the second pole piece 720. The second support surface 724 is in contact with the other end of the stationary magnet 750 to support the stationary magnet 750. FIGS. 9A to 9D illustrate the structure in which the second support surface 724 is in contact with the S-pole of the stationary magnet 750, but a structure in which the second support surface 724 is in contact with the N-pole of the stationary magnet 750 may also be applied.

As an interval Gp between the first pole piece 710 and the second pole piece 720 decreases, a region of the magnetic flow, which diverges through the first interaction surface 712 and the second interaction surface 722, decreases, but the magnetic flow is concentrated on the first interaction surface 712 and the second interaction surface 722, such that holding force to be applied to the holding object increases.

When the holding object is heavy in weight and thus high holding force is required, it is advantageous to hold the holding object in a state in which the interval Gp between the first pole piece 710 and the second pole piece 720 is short and a distance between the holding object and the first and second pole pieces 710 and 720 is short.

On the contrary, as the interval Gp between the first pole piece 710 and the second pole piece 720 increases, a region of the magnetic flow, which diverges through the first interaction surface 712 and the second interaction surface 722, increases, such that the holding object further distant from the first pole piece 710 and the second pole piece 720 may be held.

In a case in which it is necessary to hold the holding object in a state in which a distance between the holding object and the first and second pole pieces 710 and 720 is long, the long interval Gp between the first pole piece 710 and the second pole piece 720 is more advantageous than high holding force.

As described above, the interval Gp between the first pole piece 710 and the second pole piece 720 of the magnetic body holding device 700 may be adjusted in consideration of a weight of the holding object or a holding distance between the magnetic body holding device 700 and the holding object.

As the interval Gp between the first pole piece 710 and the second pole piece 720 decreases, the holding force to be applied to the holding object increases, and a magnetic flux path between the rotary magnet 730 and the first and second pole pieces 710 and 720 decreases, such that the amount of current to be supplied to the coil 740 to rotate the rotary magnet 730 decreases, and thus power consumption decreases.

However, when the interval Gp between the first pole piece 710 and the second pole piece 720 is too short, for example, when the interval Gp between the first pole piece 710 and the second pole piece 720 is short and less than 0.2 times a diameter D of the rotary magnet 730, the magnetic flux path between the rotary magnet 730 and the first and second pole pieces 710 and 720 becomes short, and as a result, there is concern that the rotary magnet 730 disposed at the second position may be arbitrarily rotated to the first position. When the rotary magnet 730 is rotated to the first position, the rotary magnet 730 forms the closed circuit together with the stationary magnet 750 as illustrated in FIG. 9A, such that the holding force applied to the holding object 1 held on the magnetic body holding device 700 is eliminated, and the holding object 1 is separated from the magnetic body holding device 700.

Therefore, the interval Gp between the first pole piece 710 and the second pole piece 720 may be equal to or longer than 0.2 times the diameter D of the rotary magnet 730.

As the interval Gp between the first pole piece 710 and the second pole piece 720 increases, even the holding object, which is further distant from the first pole piece 710 and the second pole piece 720, may be held. In addition, the magnetic flux path between the rotary magnet 730 and the first and second pole pieces 710 and 720 increases, such that it is possible to prevent the rotary magnet 730 from arbitrarily rotating to the first position in the state in which the rotary magnet 730 is disposed at the second position.

However, when the interval Gp between the first pole piece 710 and the second pole piece 720 is too long, for example, when the interval Gp between the first pole piece 710 and the second pole piece 720 exceeds 2 times the diameter D of the rotary magnet 730, the magnetic flux path between the rotary magnet 730 and the first and second pole pieces 710 and 720 becomes long. Therefore, the amount of current to be applied to the coil 740 to rotate the rotary magnet 730 to the second position in the state in which the rotary magnet 730 is disposed at the first position greatly increases, and thus power consumption also greatly increases, which may cause a deterioration in operational efficiency.

Therefore, the interval Gp between the first pole piece 710 and the second pole piece 720 may be equal to or shorter than 2 times the diameter D of the rotary magnet 730.

The coil 740 may be wound around at least one of the first pole piece 710 and the second pole piece 720. FIGS. 9A to 9D illustrate the structure in which the coil 740 is wound around the second pole piece 720, but a structure in which the coil 740 is wound around the first pole piece 710 or a structure in which the coil 740 is wound around both the first pole piece 710 and the second pole piece 720 may also be applied.

The coil 740 is disposed between the stationary magnet 750 and the rotary magnet 730.

When the current flows through the coil 740, the magnetic flow is formed in a predetermined direction by Ampere's right-handed screw rule, and the N-pole and the S-pole are formed in the direction of the magnetic flow on the second pole piece 720 around which the coil 740 is wound. That is, it can be seen that one portion of the second pole piece 720 around which the coil 740 is wound serves as an electromagnet.

The stationary magnet 750 is a permanent magnet, the N-pole of the stationary magnet 750 is disposed to be in contact with the first pole piece 710, and the S-pole of the stationary magnet 750 is disposed to be in contact with the second pole piece 720. The stationary magnet 750 is disposed to be closer to the first interaction surface 712 and the second interaction surface 722 than the rotary magnet 730.

The rotary magnet 730 includes a permanent magnet 734 and a rotary shaft 732 disposed rotatably. The permanent magnet 734 is disposed to be rotatable about the rotary shaft 732.

The rotary magnet 730 is disposed to be rotatable between a first position (see FIG. 9A) at which the S-pole of the rotary magnet 730 is adjacent to the first pole piece 710 and magnetically connected to the first pole piece 710 and the N-pole of the rotary magnet 730 is adjacent to the second pole piece 720 and magnetically connected to the second pole piece 720 and a second position (see FIG. 9C) at which the N-pole of the rotary magnet 730 is adjacent to the first pole piece 710 and magnetically connected to the first pole piece 710 and the S-pole of the rotary magnet 730 is adjacent to the second pole piece 720 and magnetically connected to the second pole piece 720.

Hereinafter, a principle of holding or releasing the holding object 1, which is the magnetic body, will be described with reference back to FIGS. 9A to 9D.

First, referring to FIG. 9A, when no power is applied to the coil 740 and thus no current flows, a portion of the first pole piece 710 being in contact with the N-pole of the stationary magnet 750, that is, the portion of the first pole piece 710, which is adjacent to the N-pole of the stationary magnet 750, is magnetized as the S-pole, and a portion of the first pole piece 710, which is relatively distant from the N-pole of the stationary magnet 750, that is, the portion of the first pole piece 710, which is adjacent to the rotary magnet 730, is magnetized as the N-pole.

On the contrary, a portion of the second pole piece 720 being in contact with the S-pole of the stationary magnet 750, that is, the portion of the second pole piece 720, which is adjacent to the S-pole of the stationary magnet 750, is magnetized as the N-pole, and a portion of the second pole piece 720, which is relatively distant from the S-pole of the stationary magnet 750, that is, the portion of the second pole piece 720, which is adjacent to the rotary magnet 730, is magnetized as the S-pole.

The rotary magnet 730 is rotated and disposed at the first position at which the S-pole of the rotary magnet 730 is adjacent to the first pole piece 710 and magnetically connected to the first pole piece 710 and the N-pole of the rotary magnet 730 is adjacent to the second pole piece 720 and magnetically connected to the second pole piece 720.

When the rotary magnet 730 is rotated and disposed at the first position, one magnetic closed loop is formed along the first pole piece 710, the rotary magnet 730, the second pole piece 720, and the stationary magnet 750, as indicated by the dotted line illustrated in FIG. 9A.

In the state in which the rotary magnet 730 is rotated and disposed at the first position, no magnetic flow is formed in the direction toward the first interaction surface 712 and the second interaction surface 722, and as a result, the holding object 1 cannot be held on the first interaction surface 712 and the second interaction surface 722.

When the coil 740 is controlled so that the current flows through the coil 740 as illustrated in FIG. 9B, the S-pole is formed on the portion of the second pole piece 720 which is adjacent to the second interaction surface 722, and the N-pole is formed on the portion of the second pole piece 720 which is adjacent to the rotary magnet 730.

When a sufficient current flows through the coil 740, the rotary magnet 730 receives repulsive force from the second pole piece 720, and the rotary magnet 730 is rotated.

When the rotary magnet 730 is rotated by 180 degrees from the first position and disposed at the second position as illustrated in FIG. 9C, the N-pole of the rotary magnet 730 is adjacent to the first pole piece 710 and magnetically connected to the first pole piece 710, and the S-pole of the rotary magnet 730 is adjacent to the second pole piece 720 and magnetically connected to the second pole piece 720.

When the rotary magnet 730 is rotated and disposed at the second position, the magnetic flow is formed on the first interaction surface 712 and the second interaction surface 722, and the magnetic flow may form the magnetic closed loop together with another magnetic body. That is, the magnetic flow diverges through the first interaction surface 712 or the second interaction surface 722. In this case, the “divergence of the magnetic flow” includes both a case in which the magnetic flow is formed to the outside from the first interaction surface 712 or the second interaction surface 722 and a case in which the magnetic flow is formed from the outside to the first interaction surface 712 or the second interaction surface 722.

Therefore, when the holding object 1 having magnetism comes into contact with the first interaction surface 712 and the second interaction surface 722, the holding object 1 forms the magnetic closed loop, as illustrated in FIG. 9C, together with the rotary magnet 730, the first pole piece 710, and the second pole piece 720, and the holding object 1 is held on the first interaction surface 712 and the second interaction surface 722 of the magnetic body holding device 700.

In addition, because the stationary magnet 750 cannot form the magnetic flow together with the rotary magnet 730 in the state in which the rotary magnet 730 is disposed at the second position, the stationary magnet 750 forms another magnetic closed loop together with the holding object 1.

When the magnetic closed loops are formed as illustrated in FIG. 9C, the magnetic closed loops are maintained even though the voltage applied to the coil 740 is eliminated, and as a result, the holding object 1 remains held.

When the coil 740 is controlled, as illustrated in FIG. 9B, in the state in which the rotary magnet 730 is disposed at the second position so that the current flows in the direction opposite to the direction of the flow of the current, the rotary magnet 730 is rotated back to the first position and forms the magnetic closed loop together with the stationary magnet 750, as illustrated in FIG. 9D, such that the holding object 1 may be separated from the magnetic body holding device 700.

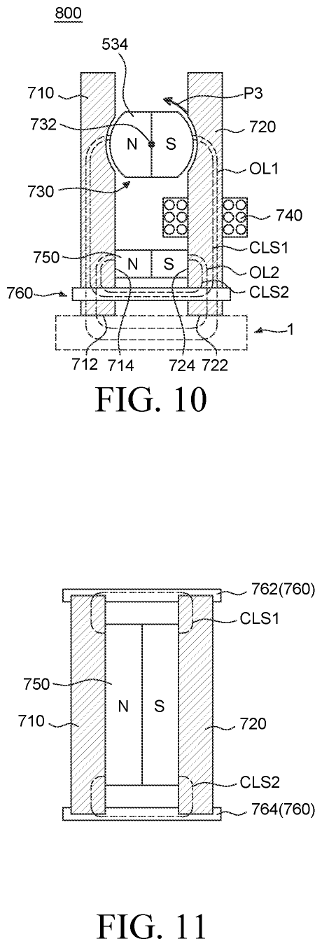

FIG. 10 is a view illustrating a state in which a sub-pole piece is mounted on the magnetic body holding device illustrated in FIG. 9A, and FIG. 11 is a bottom plan view illustrating the magnetic body holding device illustrated in FIG. 10 when viewed from a bottom side.

Referring to FIGS. 10 and 11, a magnetic body holding device 800 may further include sub-pole pieces 760 that connect the first pole piece 710 and the second pole piece 720.

The sub-pole pieces 760 may include a first sub-pole piece 762 coupled to one end of the first pole piece 710 and one end of the second pole piece 720, and a second sub-pole piece 764 coupled to the other end of the first pole piece 710 and the other end of the second pole piece 720.

The sub-pole piece 760 has a shorter length than the first pole piece 710 or the second pole piece 720 in an axial direction of the rotary magnet 730.

The first sub-pole piece 762 and the second sub-pole piece 764 form magnetic closed circuits together with one portion of the rotary magnet 730 and one portion of the stationary magnet 750, respectively.

As illustrated in FIGS. 10 and 11, in the state in which the rotary magnet 730 is disposed at the second position, the magnetic flux made by the rotary magnet 730 and the stationary magnet 750 mostly form magnetic flows OL1 and OL2 that diverge through the first interaction surface 712 of the first pole piece 710 and the second interaction surface 722 of the second pole piece 720. Therefore, the holding object 1 may be held on the first interaction surface 712 and the second interaction surface 722.

In addition, in the state in which the rotary magnet 730 is disposed at the second position, a part of the remaining magnetic flux made by the rotary magnet 730 and the stationary magnet 750 forms magnetic closed circuits CLS1 and CLS2 together with the first sub-pole piece 762 and the second sub-pole piece 764. Therefore, the rotary magnet 730 does not arbitrarily rotate to the first position in the state in which the rotary magnet 730 is disposed at the second position, and the state in which the magnetic flux diverges through the first interaction surface 712 and the second interaction surface 722 may be stably maintained.

In the state in which the rotary magnet 730 is disposed at the second position, the amount of magnetic flux diverging through the first interaction surface 712 and the second interaction surface 722 may be 70% to 90% of a sum of the amount of magnetic flux of the rotary magnet 730 and the amount of magnetic flux of the stationary magnet 750. Therefore, the amount of magnetic flux required for the first sub-pole piece 762 and the second sub-pole piece 764 to form the magnetic closed circuits together with the rotary magnet 730 and the stationary magnet 750 may be 10% to 30% of a sum of the amount of magnetic flux of the rotary magnet 730 and the amount of magnetic flux of the stationary magnet 750.

FIGS. 10 and 11 illustrate the structure in which the sub-pole pieces 760 have the first sub-pole piece 762 and the second sub-pole piece 764, but the number of sub-pole pieces 760 is not thereto. A structure in which one sub-pole piece 760 is coupled to only one of the first pole piece 710 and the second pole piece 720 or a structure in which three or more sub-pole pieces 760 are coupled to the first pole piece 710 and the second pole piece 720 may also be applied, as necessary.

Although not illustrated, it is apparent to those skilled in the art that the sub-pole piece 760 may also be applied to all the magnetic body holding devices 100, 200, 300, 400, 500, 600, and 700 according to the above-mentioned exemplary embodiments.

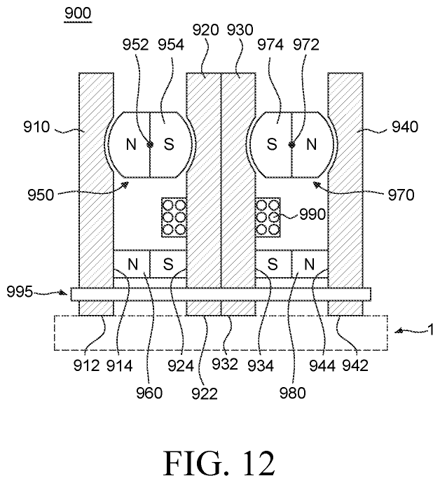

FIG. 12 is a view illustrating a modified exemplary embodiment of the magnetic body holding device illustrated in FIG. 10.

Referring to FIG. 12, a magnetic body holding device 900 includes a first pole piece 910, a second pole piece 920, a third pole piece 930, a fourth pole piece 940, a first rotary magnet 950, a first stationary magnet 960, a second rotary magnet 970, a second stationary magnet 980, and a coil 990.

The first pole piece 910 is made of a ferromagnetic material such as iron capable of forming a magnetic flow and includes a first interaction surface 912 and a first support surface 914.

The first interaction surface 912 is provided at one outer end of the first pole piece 910. When a magnetic flow is formed on the first interaction surface 912, the holding object 1 having magnetism may be held on the first interaction surface 912. The first interaction surface 912 is disposed in parallel with the second interaction surface 922, the third interaction surface 932, and the fourth interaction surface 942 in the horizontal direction so as to be stably in contact with the holding object.

The first support surface 914 is provided on an inner surface of the first pole piece 910. The first support surface 914 is in contact with one end of the first stationary magnet 960 to support the first stationary magnet 960. FIG. 9 illustrates the structure in which the first support surface 914 is in contact with the N-pole of the first stationary magnet 960, but a structure in which the first support surface 914 is in contact with the S-pole of the first stationary magnet 960 may also be applied.

As illustrated in FIG. 12, the second pole piece 920 is in contact with the third pole piece 930.

The second pole piece 920 is disposed to be spaced apart from the first pole piece 910 with the first rotary magnet 950 and the first stationary magnet 960 interposed therebetween.

The second pole piece 920 is made of a ferromagnetic material such as iron capable of forming a path through which magnetism may flow. The second pole piece 920 includes a second interaction surface 922 and a second support surface 924.

The second interaction surface 922 is provided at one outer end of the second pole piece 920. When a magnetic flow is formed on the second interaction surface 922, the holding object 1 having magnetism may be held on the second interaction surface 922. The second interaction surface 922 is disposed in parallel with the first interaction surface 912, the third interaction surface 932, and the fourth interaction surface 942 in the horizontal direction so as to be stably in contact with the holding object.

The second support surface 924 is provided on an inner surface of the second pole piece 920. The second support surface 924 is in contact with the other end of the first stationary magnet 960 to support the first stationary magnet 960. FIG. 12 illustrate the structure in which the second support surface 924 is in contact with the S-pole of the first stationary magnet 960, but a structure in which the second support surface 924 is in contact with the N-pole of the first stationary magnet 960 may also be applied.

As illustrated in FIG. 12, the third pole piece 930 is in contact with the second pole piece 920.

The third pole piece 930 is made of a ferromagnetic material such as iron capable of forming a path through which magnetism may flow. The third pole piece 930 includes a third interaction surface 932 and a third support surface 934.

The third interaction surface 932 is provided at one outer end of the third pole piece 930. When a magnetic flow is formed on the third interaction surface 932, the holding object 1 having magnetism may be held on the third interaction surface 932. The third interaction surface 932 is disposed in parallel with the first interaction surface 912, the second interaction surface 922, and the fourth interaction surface 942 in the horizontal direction so as to be stably in contact with the holding object.

The third support surface 934 is provided on an inner surface of the third pole piece 930. The third support surface 934 is in contact with one end of the second stationary magnet 980 to support the second stationary magnet 980. FIG. 12 illustrates the structure in which the third support surface 934 is in contact with the S-pole of the second stationary magnet 980, but a structure in which the third support surface 934 is in contact with the N-pole of the second stationary magnet 980 may also be applied.

The fourth pole piece 940 is disposed to be spaced apart from the third pole piece 930 with the second rotary magnet 970 and the second stationary magnet 980 interposed therebetween.

The fourth pole piece 940 is made of a ferromagnetic material such as iron capable of forming a magnetic flow and includes a fourth interaction surface 942 and a fourth support surface 944.

The fourth interaction surface 942 is provided at one outer end of the fourth pole piece 940. When a magnetic flow is formed on the fourth interaction surface 942, the holding object 1 having magnetism may be held on the fourth interaction surface 942. The fourth interaction surface 942 is disposed in parallel with the first interaction surface 912, the second interaction surface 922, and the third interaction surface 932 in the horizontal direction so as to be stably in contact with the holding object.

When the magnetic flow is formed on the first interaction surface 912, the second interaction surface 922, the third interaction surface 932, and the fourth interaction surface 942, the holding object may come into contact with the first interaction surface 912, the second interaction surface 922, the third interaction surface 932, and the fourth interaction surface 942. When the holding object is in contact with the first interaction surface 912, the second interaction surface 922, the third interaction surface 932, and the fourth interaction surface 942, the holding object forms the magnetic flow together with the first pole piece 910, the second pole piece 920, the third pole piece 930, and the fourth pole piece 940 and is held on the magnetic body holding device 900.

The fourth support surface 944 is provided on an inner surface of the fourth pole piece 940. The fourth support surface 944 is in contact with one end of the second stationary magnet 980 to support the second stationary magnet 980. FIG. 12 illustrates the structure in which the fourth support surface 944 is in contact with the N-pole of the second stationary magnet 980, but a structure in which the fourth support surface 944 is in contact with the S-pole of the second stationary magnet 980 may also be applied.

The first rotary magnet 950 includes a first permanent magnet 954 and a rotary shaft 652 disposed rotatably. The first permanent magnet 954 is disposed to be rotatable about the first rotary shaft 952.

The first rotary magnet 950 is disposed to be rotatable between a first position at which the S-pole of the first rotary magnet 950 is adjacent to the first pole piece 910 and magnetically connected to the first pole piece 910 and the N-pole of the first rotary magnet 950 is adjacent to the second pole piece 920 and magnetically connected to the second pole piece 920 and a second position at which the N-pole of the first rotary magnet 950 is adjacent to the first pole piece 910 and magnetically connected to the first pole piece 910 and the S-pole of the first rotary magnet 950 is adjacent to the second pole piece 920 and magnetically connected to the second pole piece 920.

The first stationary magnet 960 is a permanent magnet, the N-pole of the first stationary magnet 960 is disposed to be in contact with the first pole piece 910, and the S-pole of the first stationary magnet 960 is disposed to be in contact with the second pole piece 920. The first stationary magnet 960 is disposed to be closer to the first interaction surface 912 and the second interaction surface 922 than the first rotary magnet 950.

The second rotary magnet 970 includes a second permanent magnet 974 and a second rotary shaft 972 disposed rotatably. The second permanent magnet 974 is disposed to be rotatable about the second rotary shaft 972.

The second rotary magnet 970 is disposed to be rotatable between the first position at which the N-pole of the second rotary magnet 970 is adjacent to the third pole piece 930 and magnetically connected to the third pole piece 930 and the S-pole of the second rotary magnet 970 is adjacent to the fourth pole piece 940 and magnetically connected to the fourth pole piece 940 and the second position at which the S-pole of the second rotary magnet 970 is adjacent to the third pole piece 930 and magnetically connected to the third pole piece 930 and the N-pole of the second rotary magnet 970 is adjacent to the fourth pole piece 940 and magnetically connected to the fourth pole piece 940.

The second stationary magnet 980 is a permanent magnet, the S-pole of the second stationary magnet 980 is disposed to be in contact with the third pole piece 930, and the N-pole of the second stationary magnet 980 is disposed to be in contact with the fourth pole piece 940. The second stationary magnet 980 is disposed to be closer to the third interaction surface 932 and the fourth interaction surface 942 than the second rotary magnet 970.

The coil 990 may be wound around one portion of the second pole piece 920 and the third pole piece 930.

The coil 990 is disposed between the first stationary magnet 960 and the first rotary magnet 950 or between the second stationary magnet 980 and the second rotary magnet 970. In addition, the coil 990 is disposed between the first pole piece 910 and the fourth pole piece 940.

When the current flows through the coil 990, the magnetic flow is formed in a predetermined direction by Ampere's right-handed screw rule, and the N-pole and the S-pole are formed in the direction of the magnetic flow on the second pole piece 920 and the third pole piece 930 around which the coil 990 is wound. That is, it can be seen that one portion of the second pole piece 920 and the third pole piece 930 around which the coil 990 is wound serves as an electromagnet.

Because the operational principle and the function of the sub-pole piece 995 of the magnetic body holding device 900 illustrated in FIG. 12 are identical to those of the sub-pole piece 760 of the magnetic body holding device 700 described above and illustrated in FIG. 10, a detailed description thereof will be omitted.

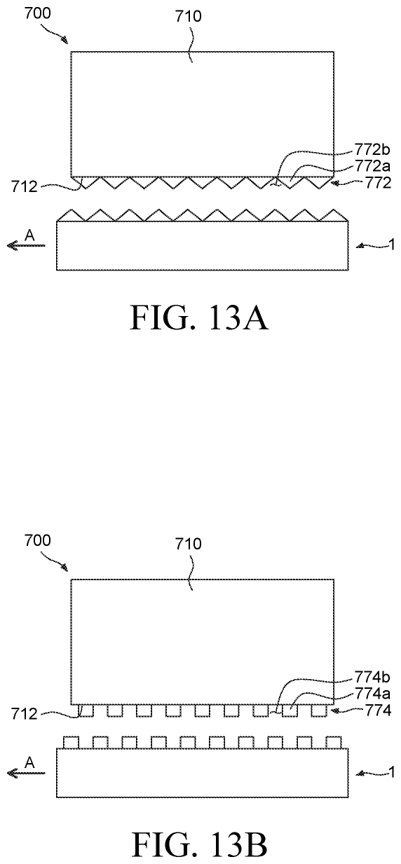

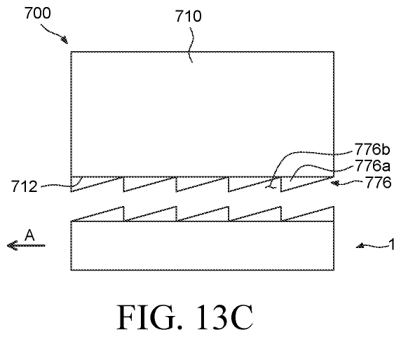

FIGS. 13A to 13C are views illustrating modified exemplary embodiments of the interaction surface of the magnetic body holding device illustrated in FIG. 9A.

As illustrated in FIGS. 13A to 13C, the first interaction surface 712 or the second interaction surface 722 may include a plurality of engagement protrusions 772, 774, and 776 protruding in one direction.

The plurality of engagement protrusions 772, 774, and 776 is provided in a shape corresponding to a holding surface of the holding object 1 and engages with the holding surface of the holding object 1 in the state in which the holding object 1 is held. Therefore, the holding object 1 may be prevented from slipping and moving relative to the magnetic body holding device 700 in the direction indicated by the arrow A1 (the horizontal direction) in the state in which the holding object 1 is held on the magnetic body holding device 700. The direction indicated by the arrow A1 may be different from the direction in which the magnetic body holding device 400 applies the holding force to the holding object 1.

As illustrated in FIGS. 13A to 13C, the plurality of engagement protrusions 772, 774, and 776 may include a plurality of crests 772a, 774a, and 776a, and a plurality of troughs 772b, 774b, and 776b formed between the plurality of crests 772a, 774a, and 776a.

The plurality of crests 772a, 774a, and 776a may have various shapes. For example, each of the plurality of crests 772a may have a triangular shape as illustrated in FIG. 13A, each of the plurality of crests 774a may have a quadrangular shape as illustrated in FIG. 13B, and each of the plurality of crests 776a may have an asymmetric triangular shape as illustrated in FIG. 13C. In addition, it is apparent to those skilled in the art that other shapes, which enable the holding object 1 and the first interaction surface 712 or the second interaction surface 722 to engage with each other, may also be applied in addition to the shapes of the plurality of engagement protrusions 772, 774, and 776 illustrated in FIGS. 13A to 13C.

Although not illustrated, it is apparent to those skilled in the art that the plurality of engagement protrusions 772, 774, and 776 may be applied to all the interaction surfaces of the magnetic body holding devices 100, 200, 300, 400, 500, 600, 800, and 900 according to the above-mentioned exemplary embodiments.

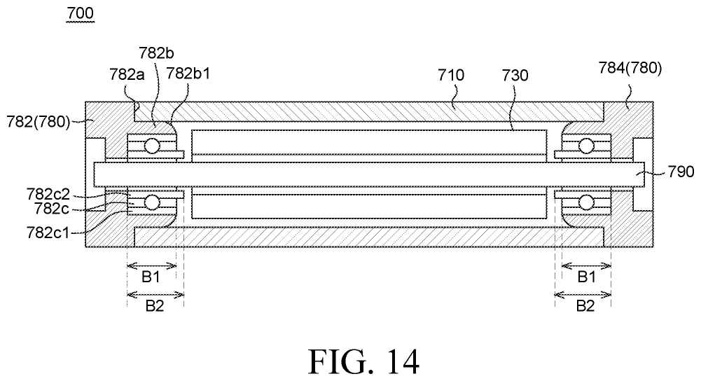

FIG. 14 is a view illustrating a state in which covers are coupled to both ends of the pole pieces illustrated in FIG. 9A.

As illustrated in FIG. 14, the magnetic body holding device 700 may further include cover members 780 coupled to both ends of the first pole piece 710 and the second pole piece 720, and a shaft 790 coupled to the rotary magnet 730 while penetrating a center of the rotary magnet 730.

The cover members 780 include a first cover 782 coupled to one end of the first pole piece 710 and one end of the second pole piece 720 to support one end of the shaft 790 so that the shaft 790 is rotatable, and a second cover 784 coupled to the other end of the first pole piece 710 and the other end of the second pole piece 720 to support the other end of the shaft 790 so that the shaft 790 is rotatable.

The second cover 784 has the same structure as the first cover 782, and there is only a difference between the second cover 784 and the first cover 782 in terms of positions at which the first pole piece 710 and the second pole piece 720 are coupled. Therefore, the description will be made focusing on the structure of the first cover 782.

The first cover 782 includes an insertion protrusion 782b that protrudes from one surface 782a of the first cover 782, which adjoins one end of the first pole piece 710 and one end of the second pole piece 720 and is inserted between the first pole piece 710 and the second pole piece 720.

The insertion protrusion 782b may be shaped such that a cross-sectional area of is decreased in a direction in which the insertion protrusion 782b is inserted. Therefore, the insertion protrusion 782b may be smoothly inserted between the first pole piece 710 and the second pole piece 720.

For example, the shape of the insertion protrusion 782b having the cross-sectional area, which is decreased, may include a rounded portion 782b1, as illustrated in FIG. 14. Further, although not illustrated, the shape of the insertion protrusion 782b having the cross-sectional area, which is decreased, may include a chamfered shape formed as outer surface of the insertion protrusion 782b is inclined in the direction in which the insertion protrusion 782b is inserted.

The first cover 782 may further include at least one bearing 782c coupled to the insertion protrusion 582b and configured to support the shaft 790 so that the shaft 790 is rotatable.

The bearing 782c includes an outer race 782c1 fixed inside the insertion protrusion 782b, and an inner race 782c2 provided to be rotatable relative to the outer race 782c1. The shaft 790 is fixed to the inner race 782c2.

The inner race 782c2 of the bearing 782c further protrudes toward the rotary magnet 730 than the outer race 782c1 of the bearing 782c. That is, a length B2 of the inner race 782c2 has a larger value than a length B1 of the outer race 782c1 in an axial direction of the shaft 790.

The shaft 790 may sway in the axial direction thereof while the shaft 790 rotates. In this case, the rotary magnet 730 fixed to the shaft 790 may also sway together with the shaft 790 in the axial direction of the shaft 790.

According to the present exemplary embodiment, because the inner race 782c2 of the bearing 782c further protrudes toward the rotary magnet 730 than the outer race 782c1 of the bearing 782c. Therefore, even if one end of the rotary magnet 730 and the bearing 782c come into contact with each other as the rotary magnet 730 repeatedly sways in the axial direction of the shaft 790, one end of the rotary magnet 730 comes into contact with only the inner race 782c2 of the bearing 782c without coming into contact with the outer race 782c1 of the bearing 782c. Therefore, it is possible to minimize a situation in which the rotary magnet 730 is not rotated or heat or noise is generated while the rotary magnet 730 rotates because of frictional force between the rotary magnet 730 and the bearing 782c.

Although not illustrated, it is apparent to those skilled in the art that the cover member 780 may be applied to all the magnetic body holding devices 100, 100′, 200, 200′, 300, 400, 500, 600, 800, and 900 according to the above-mentioned exemplary embodiments.

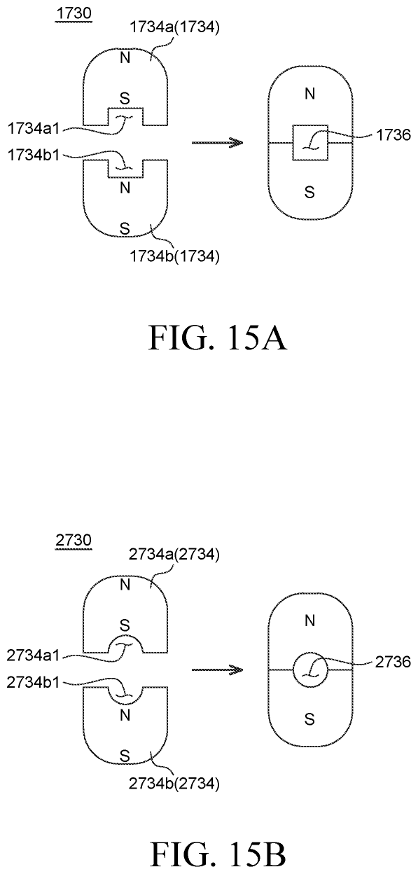

FIGS. 15A and 15B are views illustrating modified exemplary embodiments of the rotary magnet.

As illustrated in FIGS. 15A and 15B, rotary magnets 1730 and 2730 have center holes 1736 and 2736, respectively, into which the shaft 790 (see FIG. 11) is inserted and fixed.

Each of the center holes 1736 and 2736 may have a polygonal shape such as a quadrangular shape or have a circular shape.

As illustrated in FIG. 15A, in the structure in which the center hole 1736 has a quadrangular shape, coupling force between the shaft 790 and the center hole 1736 is high, and as a result, it is possible to effectively prevent the rotary magnet 1730 from slipping and rotating relative to the shaft 790.

As illustrated in FIG. 15B, in the structure in which the center hole 2736 has a circular shape, positional precision (roundness) of the center hole 2736 is improved, and as a result, there is an advantage in that the magnetic body holding device 700 with higher precision and reliability may be manufactured.

In addition, the rotary magnets 1730 and 2730 include permanent magnets 1734 and 2734, respectively. Each of the permanent magnets 1734 and 2734 may include a pair of magnets 1734a and 1734b or 2734a and 2734b coupled to each other to define the center holes 1736 and 2736.

As illustrated in FIG. 15A, the magnet parts 1734a and 1734b include rectangular grooves 1534a1 and 1534b1, respectively, to form the center hole 1736. As illustrated in FIG. 15B, the magnet parts 2534a and 2534b include semicircle grooves 2534a1 and 2534b1, respectively, to form the center hole 2736.

When the grooves 1734a1 and 1734b1 or 2734a1 and 2734b1 of the magnet parts 1734a and 1734b or 2734a and 2734b are disposed to face each other, the opposite polarities are disposed to face each other, and as a result, the magnet parts 1734a and 1734b or 2734a and 2734b are coupled strongly, thereby forming the rotary magnets 1730 and 2730 having the center holes 1736 and 2736.

As described above, since the rotary magnets 1730 and 2730 are formed by coupling the magnet parts 1734a and 1734b or 2734a and 2734b having the grooves 1734a1 and 1734b1 or 2734a1 and 2734b1, there is an advantage in that positional precision (roundness) of the center holes 1736 and 2736 is improved and the magnetic body holding device 700 with higher precision and reliability may be manufactured.

In addition, in comparison with the method of manufacturing the rotary magnet by forming the hole at the center of one permanent magnet, the method of manufacturing the rotary magnet by coupling the two magnet parts 1734a and 1734b or 2734a and 2734b is advantageous in improving processing convenience, reducing manufacturing costs, and improving productivity.

Although not illustrated, it is apparent to those skilled in the art that the rotary magnets 1730 and 2730 including the magnet parts 1734a and 1734b or 2734a and 2734b may also be applied to all the rotary magnets of the magnetic body holding devices 100, 100′, 200, 200′, 300, 400, 500, 600, 800, and 900 according to the above-mentioned exemplary embodiments.

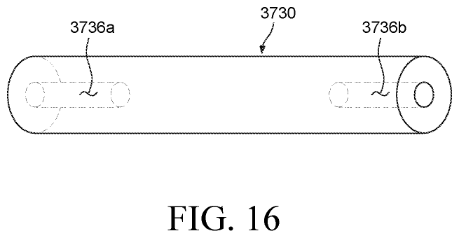

FIG. 16 is a view illustrating another modified exemplary embodiment of the rotary magnet.

As illustrated in FIG. 16, a rotary magnet 3730 may include insertion holes 3736a and 3736b into which shafts are insert and fixed.

The insertion holes 3736a and 3736b include a first insertion hole 3736a concavely formed by a predetermined depth toward a center of the rotary magnet 3730 at one end of the rotary magnet 3730, and a second insertion hole 3736b concavely formed by a predetermined depth toward the center of the rotary magnet 3730 at the other end of the rotary magnet 3730.

As described above, since the first insertion hole 3736a and the second insertion hole 3736b, which each have a predetermined depth, are formed at both ends of the rotary magnet 3730, there are advantages in that positional precision (roundness) of the first insertion hole 3736a and the second insertion hole 3736b is improved and the magnetic body holding device 700 with higher precision and reliability may be manufactured.

In addition, in comparison with the method of manufacturing the rotary magnet by forming a hole completely penetrating a center of one permanent magnet, the method of manufacturing the rotary magnet by forming the first insertion hole 3736a and the second insertion hole 3736b each having a predetermined depth at both ends of the rotary magnet 3730 is advantageous in improving processing convenience, reducing manufacturing costs, and improving productivity.

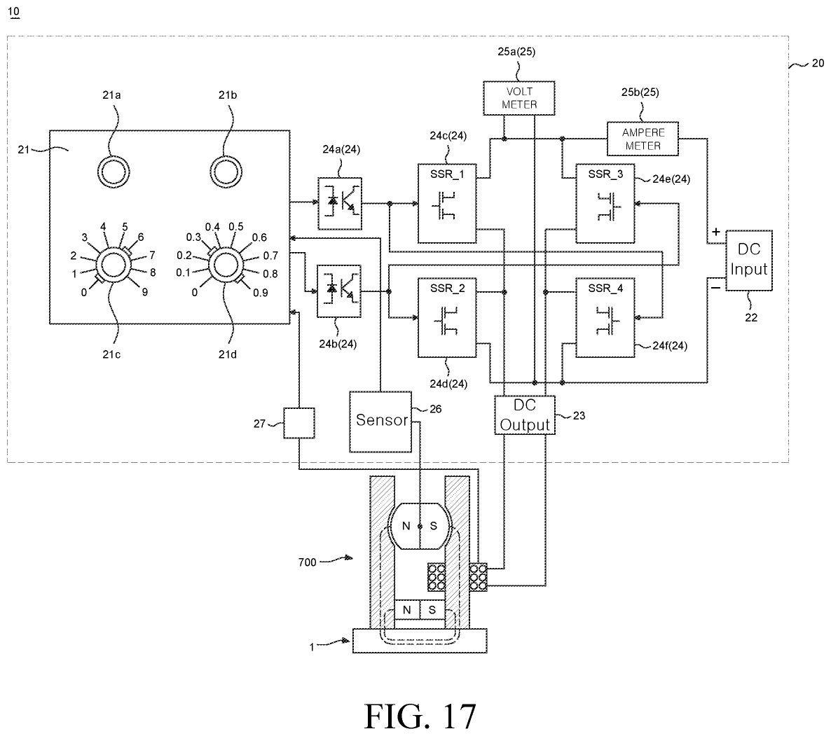

FIG. 17 is a view schematically illustrating a magnetic body holding system according to an exemplary embodiment of the present disclosure.

A magnetic body holding system 10 includes the magnetic body holding device 100, 100′, 200, 200′, 300, 400, 500, 600, 700, 800, or 900, and a control device 20 configured to hold the holding object 1 on the magnetic body holding device 100, 100′, 200, 200′, 300, 400, 500, 600, 700, 800, or 900 or release the holding object 1 held on the magnetic body holding device 100, 100′, 200, 200′, 300, 400, 500, 600, 700, 800, or 900 by controlling the current flowing through the coil 150, 304, 504, 690, 740, or 990.

As illustrated in FIG. 17, the control device 20 includes a main control unit 21, a direct current (DC) input unit 22, a DC output unit 23, a switch unit 24, display units 25, a sensor unit 26, a temperature sensor 27, and the like.

The main control unit 21 includes a holding button 21a, a holding release button 21b, voltage output adjusting buttons 21c and 21d, and the like. When the holding button 21a is pushed, the current flows through the coil 150, 304, 504, 690, 740, or 990 in one direction by the switch unit 24 and the DC output unit 23, and the magnetic body holding device 100, 100′, 200, 200′, 300, 400, 500, 600, 700, 800, or 900 may hold the holding object 1 or release the holding object 1.

In contrast, when the holding release button 21b is pushed, the current flows through the coil 150, 304, 504, 690, 740, or 990 in the direction opposite to one direction by the switch unit 24 and the DC output unit 23, and the magnetic body holding device 100, 100′, 200, 200′, 300, 400, 500, 600, 700, 800, or 900 cannot release the holding object 1 or hold the holding object 1.

The voltage output adjusting buttons 21c and 21d include an output amount adjusting button 21c and an output time adjusting button 21d, and the output amount adjusting button 21c and the output time adjusting button 21d may be rotatably provided on the main control unit 21. The amount of current outputted from the DC output unit 23 or the output time may be adjusted by manipulating the voltage output adjusting buttons 21c and 21d.

In addition to the function of holding and releasing the holding object and the function of adjusting voltage output, the main control unit 21 may further perform a function of automatically restricting the current in order to prevent overcurrent from flowing through the coil 150, 304, 504, 690, 740, or 990, and a function of notifying that the current does not flow through the coil 150, 304, 504, 690, 740, or 990.

The switch unit 24 includes a holding switch 24a which receives a holding signal and activate the holding signal when the holding button 21a of the main control unit 21 is pushed, a holding release switch 24b which receives a holding release signal and activates the holding release signal when the holding release button 21b of the main control unit 21 is pushed, and circuit switches 24c, 24d, 24e, and 24f disposed on a circuit between the DC input unit 22 and the DC output unit 23. The circuit switches 24c, 24d, 24e, and 24f may include solid state relays (SSRs) and the like.

As the holding switch 24a or the holding release switch 24b is activated, the circuit switches 24c, 24d, 24e, and 24f perform switching functions between the DC input unit 22 and the DC output unit 23 to output the current selectively in one direction or a direction opposite to one direction by the DC output unit 23.

Specifically, the circuit switches 24c, 24d, 24e, and 24f include a first circuit switch 24c, a second circuit switch 24d, a third circuit switch 24e, and a fourth circuit switch 24f.

When the holding switch 24a is activated, the first circuit switch 24c and the fourth circuit switch 24f are activated to connect the DC input unit 22 and the DC output unit 23. In this case, the current flows through the coil 150, 304, 504, 690, 740, or 990 in one direction by the DC output unit 23 so that the magnetic body holding device 100, 100′, 200, 200′, 300, 400, 500, 600, 700, 800, or 900 may hold the holding object 1.

When the holding release switch 24b is activated, the second circuit switch 24d and the third circuit switch 24e are activated to connect the DC input unit 22 and the DC output unit 23. In this case, the current flows through the coil 150, 304, 504, 690, 740, or 990 in the direction opposite to one direction by the DC output unit 23 so that the magnetic body holding device 100, 100′, 200, 200′, 300, 400, 500, 600, 700, 800, or 900 may release the holding object 1.

The display units 25 includes a voltage display unit 25a disposed on an electric circuit for connecting the DC input unit 22 and the DC output unit 23 and configured to display DC voltage, and a current display unit 25b configured to display DC current.

The sensor unit 26 is electromagnetically connected to the main control unit 21, detects a hold state or a release state of the magnetic body holding device 100, 100′, 200, 200′, 300, 400, 500, 600, 700, 800, or 900, and transmits the detection information to the main control unit 21.

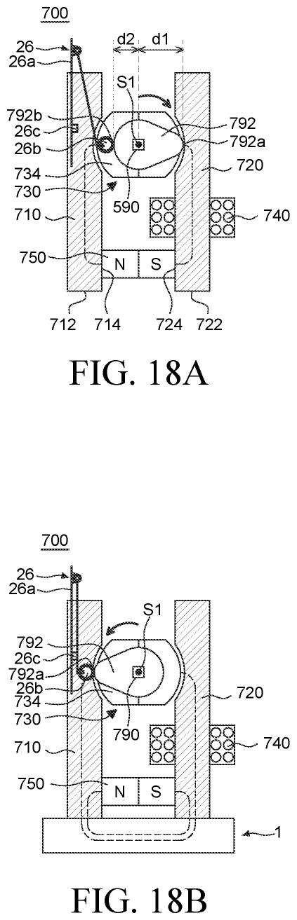

The sensor unit 26 includes a sensor main body 26a (see FIG. 16A), and a sensor switch 26b (see FIG. 18A) connected to the sensor main body 26a and configured to be pressed by a cam 792 (see FIG. 18A) to be described below in accordance with a rotation of the cam 792.

The temperature sensor 27 is electromagnetically connected to the main control unit 21, detects a temperature of the coil 150, 304, 504, 690, 740, or 990 and resistance of the coil 150, 304, 504, 690, 740, or 990, and transmits values of the detected temperature and resistance of the coil 150, 304, 504, 690, 740, or 990 to the main control unit 21.

The main control unit 21 connected to the temperature sensor 27 receives the values of the temperature and resistance of the coil 150, 304, 504, 690, 740, or 990 from the temperature sensor 27, and may further perform a function of notifying of disconnection of the coil 150, 304, 480, 540, or 690 when the coil 150, 304, 480, 540, or 690 is disconnected.

FIGS. 18A and 18B are views illustrating a structure in which a detection sensor and a cam mounted on the magnetic body holding device illustrated in FIG. 9A operate in conjunction with each other.

Referring to FIGS. 18A and 18B, the magnetic body holding device 700 further includes the cam 792 coupled to one end of the shaft 790 and configured to rotate together with the shaft 790.

The cam 792 is configured to be in contact with the sensor switch 26b. The cam 792 includes a pressing surface 792a formed at a position distant from a rotation center 51 of the shaft 790 at a first distance d1, and a releasing surface 792b formed at a position distant from the rotation center 51 of the shaft 790 at a second distance d2 shorter than the first distance d1.

As described above, when the rotary magnet 730 is disposed at the first position, the rotary magnet 730 forms the magnetic closed loop together with the stationary magnet 750, and the magnetic body holding device 700 cannot hold the holding object 1.

As illustrated in FIG. 18A, the releasing surface 792b of the cam 792 comes into contact with the sensor switch 26b, such that the sensor switch 26b is rotated toward the shaft 790. When the sensor switch 26b is rotated toward the shaft 790, the sensor switch 26b deviates from a sensing line 26c such as an infrared ray formed on the sensor main body 26a.

The sensor unit 26 transmits information, which indicates that the sensor switch 26b deviates from the sensing line 26c and no interference occurs, to the main control unit 21. For example, the information, which indicates that no interference occurs, may mean the time for which the sensor switch 26b completely deviates from the sensing line 26c and remains undetected.

The main control unit 21, which receives the information from the sensor unit 26, may perform a function of notifying that the magnetic body holding device 700 is in the release state.

On the contrary, when the rotary magnet 730 is rotated and disposed at the second position, the rotary magnet 730 and the stationary magnet 750 form the magnetic flows that diverge through the interaction surfaces 712 and 722, and the magnetic body holding device 700 can hold the holding object 1.

As illustrated in FIG. 18B, the pressing surface 792a of the cam 792 comes into contact with the sensor switch 26b, such that the sensor switch 26b is rotated toward the sensor main body 26a. When the sensor switch 26b is rotated toward the sensor main body 26a, the sensor switch 26b interferes with the sensing line 26c such as an infrared ray formed on the sensor main body 26a.

The sensor unit 26 transmits information, which is detected as the sensor switch 26b interferes with the sensing line 26c, to the main control unit 21. For example, the information, which indicates that the interference occurs, may mean the time for which the sensor switch 26b interferes with the sensing line 26c and the sensing is maintained.

The main control unit 21, which receives the information from the sensor unit 26, may perform a function of notifying that the magnetic body holding device 700 is in the hold state.

Although not illustrated, the sensor unit 26 may have a structure including a Hall sensor using a Hall effect. The Hall sensor detects whether the holding object 1 is held or released based on a change in magnetic field in accordance with the rotation of the rotary magnet 730.

It is apparent to those skilled in the art that the sensor unit 26, which includes the sensor main body 26a and the sensor switch 26b, and the cam 792, which operates in conjunction with the sensor unit 26, may also applied to all the magnetic body holding devices 100, 100′, 200, 200′, 300, 400, 500, 600, 800, and 900 according to the above-mentioned exemplary embodiments.

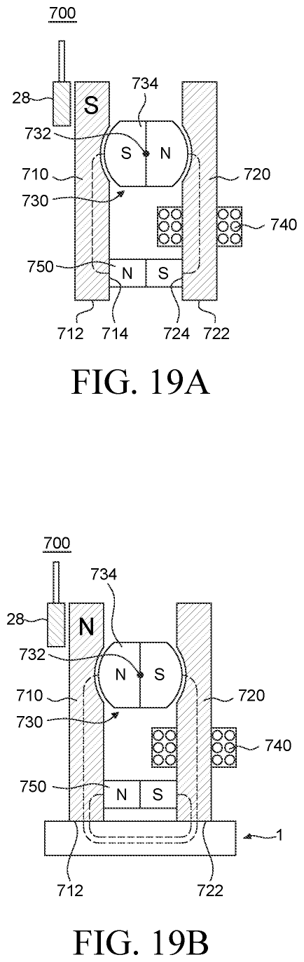

FIGS. 19A and 19B are views illustrating a structure in which a magnetic sensor for detecting a polarity of the magnetic body holding device illustrated in FIG. 9A is disposed.

Referring to FIGS. 19A and 19B, a magnetic sensor 28 may be disposed to be spaced apart from the first pole piece 710 and may detect the polarity of the first pole piece 710.

The magnetic sensor 28 is a sensor for measuring a size and a direction of a magnetic field or a line of magnetic force. The magnetic sensor 28 may detect the polarity of the first pole piece 710, which is magnetized in accordance with the rotation direction of the rotary magnet 730 and transmit the detected value to the main control unit 21.

When no power is applied to the coil 740 and thus no current flows, the portion of the first pole piece 710 being in contact with the N-pole of the stationary magnet 750, that is, the portion of the first pole piece 710, which is adjacent to the N-pole of the stationary magnet 750, is magnetized as the S-pole, and a portion of the first pole piece 710, which is relatively distant from the N-pole of the stationary magnet 750, that is, the portion of the first pole piece 710, which is adjacent to the rotary magnet 730, is magnetized as the N-pole.

Therefore, the rotary magnet 730 is rotated and disposed at the first position at which the S-pole of the rotary magnet 730 is adjacent to the first pole piece 710 and magnetically connected to the first pole piece 710 and the N-pole of the rotary magnet 730 is adjacent to the second pole piece 720 and magnetically connected to the second pole piece 720.

When the rotary magnet 730 is rotated and disposed at the first position, the rotary magnet 730 forms the magnetic closed loop together with the stationary magnet 750, and the magnetic body holding device 700 cannot hold the holding object 1.

As illustrated in FIG. 19A, when the rotary magnet 730 is disposed at the first position, the magnetic sensor 28 detects the polarity of the portion of the first pole piece 710, which is adjacent to the rotary magnet 730 and magnetized as the S-pole, and transmits information about the detected polarity to the main control unit 21.

The main control unit 21, which receives the information from the magnetic sensor 28, may perform a function of notifying that the magnetic body holding device 700 is in the release state.

When the rotary magnet 730 is rotated by 180 degrees from the first position and disposed at the second position, the N-pole of the rotary magnet 730 is adjacent to the first pole piece 710 and magnetically connected to the first pole piece 710, and the S-pole of the rotary magnet 730 is adjacent to the second pole piece 720 and magnetically connected to the second pole piece 720.

As illustrated in FIG. 19B, when the rotary magnet 730 is rotated and disposed at the second position, the rotary magnet 730 and the stationary magnet 750 form the magnetic flows that diverge through the interaction surfaces 712 and 722, and the magnetic body holding device 700 can hold the holding object 1.

When the rotary magnet 730 is disposed at the second position, the magnetic sensor 28 detects the polarity of the portion of the first pole piece 710, which is adjacent to the rotary magnet 730 and magnetized as the N-pole, and transmits information about the detected polarity to the main control unit 21.

The main control unit 21, which receives the information from the magnetic sensor 28, may perform a function of notifying that the magnetic body holding device 700 is in the hold state.

It is apparent to those skilled in the art that the magnetic sensor 28 may also be applied to all the magnetic body holding devices 100, 100′, 200, 200′, 300, 400, 500, 600, 800, and 900 according to above-mentioned exemplary embodiments.

While the exemplary embodiments of the present disclosure have been illustrated and described above, the present disclosure is not limited to the specific exemplary embodiments, and various modifications can of course be made by those skilled in the art to which the present disclosure pertains without departing from the subject matter of the present disclosure as claimed in the claims. Further, the modifications should not be appreciated individually from the technical spirit or prospect of the present disclosure.

What is claimed is:

1. A magnetic body holding device comprising:
a first pole piece having a first interaction surface and a second interaction surface;
a second pole piece spaced apart from the first pole piece and having a third interaction surface and a fourth interaction surface;
a first stationary magnet supported between the first pole piece and the second pole piece and disposed to be adjacent to the first interaction surface and the third interaction surface;
a second stationary magnet supported between the first pole piece and the second pole piece and disposed to be adjacent to the second interaction surface and the fourth interaction surface;
a rotary magnet rotatably disposed between the first stationary magnet and the second stationary magnet;
a first coil disposed between the first stationary magnet and the rotary magnet and wound around at least one of the first pole piece and the second pole piece; and
a second coil disposed between the second stationary magnet and the rotary magnet and wound around at least one of the first pole piece and the second pole piece.

2. The magnetic body holding device of claim 1,
wherein the rotary magnet is disposed at a first position and a second position at which the rotary magnet rotated from the first position is positioned by controlling current flowing through the first coil and the second coil,
wherein the rotary magnet forms different magnetic closed loops together with the first stationary magnet and the second stationary magnet when the rotary magnet is disposed at the first position, and
wherein the rotary magnet forms a first magnetic flow, which diverges through the first interaction surface and the third interaction surface, and a second magnetic flow, which diverges through the second interaction surface and the fourth interaction surface, when the rotary magnet is disposed at the second position.

3. The magnetic body holding device of claim 1, wherein one portion of the rotary magnet forms a magnetic closed loop together with any one of the first stationary magnet and the second stationary magnet, and
wherein the other portion of the rotary magnet forms a magnetic flow that diverges through any one pair of interaction surfaces among the first interaction surface, the third interaction surface, the second interaction surface, and the fourth interaction surface.

4. The magnetic body holding device of claim 1, wherein the first stationary magnet is disposed to be closer to the first interaction surface and the third interaction surface than the first coil.

5. The magnetic body holding device of claim 1, wherein the first stationary magnet is disposed to be closer to the first interaction surface and the third interaction surface than the first rotary magnet.

6. A magnetic body holding device comprising:
a first magnetic body holding module comprising:
a first pole piece assembly having a plurality of pole pieces made of a ferromagnetic material;
a pair of first stationary magnets disposed between the plurality of pole pieces; and
a first rotary magnet disposed between the pair of first stationary magnets and configured to form a magnetic closed loop together with at least one of the pair of first stationary magnets or form a magnetic flow that diverges to the outside of the first pole piece assembly;
a second magnetic body holding module comprising:
a second pole piece assembly having a plurality of pole pieces made of a ferromagnetic material;
a pair of second stationary magnets disposed between the plurality of pole pieces; and
a second rotary magnet disposed between the pair of second stationary magnets and configured to form a magnetic closed loop together with at least one of the pair of second stationary magnets or form a magnetic flow that diverges to the outside of the second pole piece assembly;
a diamagnetic body disposed between the first magnetic body holding module and the second magnetic body holding module; and
a plurality of coils shared by the first magnetic body holding module and the second magnetic body holding module.

7. The magnetic body holding device of claim 6, wherein at least one of the plurality of coils is wound around at least one portion of the first pole piece assembly and at least one portion of the second pole piece assembly.

8. The magnetic body holding device of claim 6, wherein the plurality of coils comprises:
a first coil disposed between the first rotary magnet and any one of the pair of first stationary magnets and between the second rotary magnet and any one of the pair of second stationary magnets; and
a second coil disposed between the first rotary magnet and the other of the pair of first stationary magnets and between the second rotary magnet and the other of the pair of second stationary magnets.

9. The magnetic body holding device of claim 6, wherein any one of the pair of first stationary magnets and any one of the pair of second stationary magnets are disposed so that the same poles face each other.

10. The magnetic body holding device of claim 6, wherein the first magnetic body holding module and the second magnetic body holding module are disposed in a vertical direction.

11. The magnetic body holding device of claim 6, wherein the first pole piece assembly comprises:
a first pole piece having a first interaction surface and a second interaction surface; and
a second pole piece having a third interaction surface and a fourth interaction surface,
wherein the second pole piece assembly comprises:
a third pole piece having a fifth interaction surface and a sixth interaction surface; and
a fourth pole piece having a seventh interaction surface and an eighth interaction surface, and
wherein the diamagnetic body is disposed between the second pole piece and the third pole piece.

12. A magnetic body holding device comprising:
at least one stationary magnet;
at least one rotary magnet rotatably disposed;
a plurality of pole pieces disposed to provide magnetic paths and having interaction surfaces on which a holding object is held; and
a coil wound around at least one of the plurality of pole pieces,
wherein the plurality of pole pieces comprises:
a first pole piece configured to support the stationary magnet; and
a second pole piece disposed adjacent to the first pole piece, and
wherein an interval between the first pole piece and the second pole piece is equal to or longer than 0.2 times of a diameter of the rotary magnet and equal to or shorter than 2 times the diameter of the rotary magnet.

13. The magnetic body holding device of claim 12, further comprising:
a sub-pole piece disposed to connect at least one portion of the first pole piece and at least one portion of the second pole piece and configured to form a magnetic closed loop together with at least one stationary magnet or at least one rotary magnet.
